(19) United States
(12) Patent Application Publication
(10) Pub. No.: US 2022/0344950 A1
(43) Pub. Date: Oct. 27, 2022

(54) CHARGING CONTROLING CIRCUITS

(71) Applicant: SHENZHEN SHOKZ CO., LTD., Shenzhen (CN)

(72) Inventors: Yunbin CHEN, Shenzhen (CN); Fen YOU, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 17/811,074

(22) Filed: Jul. 7, 2022

Related U.S. Application Data
(63) Continuation of application No. PCT/CN2021/087896, filed on Apr. 16, 2021.

(30) Foreign Application Priority Data
Apr. 24, 2020 (CN) 202010331941.9
Dec. 7, 2020 (CN) 202011431449.5
Dec. 7, 2020 (CN) 202011431484,7
Dec. 16, 2020 (CN) 202011489718,3

(51) Int. Cl. H02J 7/00

(52) U.S. Cl. CPC H02J 7/0036; H02J 7/007; H02J 7/00304

(57) ABSTRACT

The present disclosure discloses a charging control circuit, which comprises: a charging circuit configured to be connected to a charging line or an external device, and the charging circuit generates a charging voltage difference after being connected to the charging line or the external device; a detection circuit including at least one detection terminal for detecting voltage information of the at least one detection terminal; and a control circuit configured to perform a predetermined action based on the charging voltage difference and the voltage information.

### CROSS-REFERENCE TO RELATED APPLICATION

This application is a Continuation of International Patent Application No. PCT/CN2021/087896, filed on Apr. 16, 2021, which claims priority of Chinese Patent Application No. 202010331941.9 filed on Apr. 24, 2020, Chinese Patent Application No. 202011431449.5 filed on Dec. 7, 2020, Chinese Patent Application No. 202011431484.7 filed on Dec. 7, 2020, and Chinese Patent Application No. 202011489718.3 filed on Dec. 16, 2020, the entire contents of which are hereby incorporated by reference.

### TECHNICAL FIELD

The present disclosure relates to the field of circuits, in particular to charging control circuits.

### BACKGROUND

During the use of a wearable device or a rechargeable electronic device, residual liquid (e.g., sweat, rain, etc.) may exist. The residual liquid may flow to a charging interface of the wearable device or the rechargeable electronic device in some ways, resulting in a short circuit of the charging interface and burning the charging interface.

Therefore, it is desirable to provide a charging control circuit that may detect the residual liquid on the wearable device or the rechargeable electronic device and protect the charging interface.

### SUMMARY

One of the embodiments of the present disclosure discloses a charging control circuit, comprising: a charging circuit, configured to be connected to a charging line or an external device, wherein the charging circuit generates a charging voltage difference after being connected to the charging line or the external device. A detection circuit, including at least one detection terminal, wherein the detection circuit is configured to detect voltage information of the at least one detection terminal. And a control circuit configured to perform a predetermined action based on the charging voltage difference and the voltage information.

In some embodiments, the voltage information at least includes a voltage value and/or a voltage change value of the at least one detection terminal, and wherein to perform the predetermined action based on the charging voltage difference and the voltage information, the control circuit performs operations including: in response to the charging voltage difference and the voltage value and/or the voltage change value of the at least one detection terminal satisfying a predetermined condition, performing the predetermined action.

In some embodiments, the predetermined condition includes: the charging circuit generates the charging voltage difference, and the voltage value and/or the voltage change value is greater than a predetermined value.

In some embodiments, the charging circuit at least includes a first charging terminal and a second charging terminal, the first charging terminal and the second charging terminal are configured to contact electrode terminals corresponding to the charging line or the external device, and at least part of the at least one detection terminal is located between the first charging terminal and the second charging terminal.

In some embodiments, the charging control circuit further comprises a shell configured to accommodate the charging circuit, the detection circuit, and the control circuit. Wherein an external surface of the shell is disposed with a charging slot, the charging slot is disposed with a first electrode seat and a second electrode seat that are protruded from a bottom surface of the charging slot and disposed at intervals. The first charging terminal and the second charging terminal are respectively embedded in the first electrode seat and the second electrode seat. And at least part of the at least one detection terminal is located on the bottom surface of the charging slot between the first electrode seat and the second electrode seat, and lower than the first charging terminal and the second charging terminal.

In some embodiments, the at least one detection terminal is exposed to the external surface of the shell; at least part of the at least one detection terminal is located on a connecting line between the first charging terminal and the second charging terminal, and extends on the external surface of the shell along a direction perpendicular to the connecting line.

In some embodiments, the at least one detection terminal is a completely closed or not completely closed electrode structure, and the first charging terminal or the second charging terminal is located in a space region surrounded by the at least one detection terminal.

In some embodiments, the charging control circuit further comprises a first voltage regulator, a first voltage dividing resistor, and a second voltage dividing resistor, one end of the first voltage dividing resistor is connected to the first voltage regulator, the other end of the first voltage dividing resistor is connected to the at least one detection terminal and one end of the second voltage dividing resistor, respectively, and the other end of the second voltage dividing resistor is grounded.

In some embodiments, the charging control circuit further comprises the first charging terminal is a positive electrode terminal, the second charging terminal is a negative electrode terminal, the first voltage regulator is connected to the first charging terminal, the first voltage regulator is configured to output a processed voltage to the first voltage dividing resistor, wherein the processed voltage is obtained by stabilizing and reducing a voltage from the first charging terminal, and the other end of the second voltage dividing resistor is connected to the second charging terminal.

In some embodiments, the charging control circuit further comprises an output module coupled with the control circuit, wherein the control circuit controls the output module to perform the predetermined action based on the charging voltage difference and the voltage information.

In some embodiments, the charging line includes: a power interface, configured to connect to a power adapter to receive a charging voltage; a charging interface, configured to connect to the charging circuit; a signal transmission line connected between the power interface and the charging interface, wherein the signal transmission line includes a charging-voltage transmission line and a ground-voltage transmission line; and a current limiting device connected to the charging-voltage transmission line to limit a current through the charging interface.

In some embodiments, the current limiting device is a self-adjusting resistor, and the greater the current through the self-adjusting resistor is, the greater a resistance value of the self-adjusting resistor is.

In some embodiments, the current limiting device is disposed in the power interface, the charging interface, or the signal transmission line.

In some embodiments, the charging line further includes a second voltage regulator connected between the charging-voltage transmission line and the ground-voltage transmission line to limit the charging voltage on the charging interface.

In some embodiments, the second voltage regulator is disposed in the power interface, the charging interface or the signal transmission line.

In some embodiments, the power interface includes a first power terminal and a first ground terminal, the charging interface includes a second power terminal and a second ground terminal, the first power terminal of the power interface and the second power terminal of the charging interface are connected through the charging-voltage transmission line, and the first ground terminal of the power interface and the second ground terminal of the charging interface are connected through the ground-voltage transmission line.

In some embodiments, the power interface includes a first end and a second end, the charging interface includes a corresponding first end and a corresponding second end. The signal transmission line includes a first transmission line and a second transmission line, the first end of the power interface and the first end of the charging interface are connected through the first transmission line, the second end of the power interface and the second end of the charging interface are connected through the second transmission line. And when the first end of the power interface is connected to a power pin of an interface of the power adapter, the first transmission line is the charging-voltage transmission line, and the second transmission line is the ground-voltage transmission line.

In some embodiments, the charging line includes a first current limiting device and a second current limiting device, the first current limiting device is connected to the first transmission line, and the second current limiting device is connected to the second transmission line.

In some embodiments, the charging control circuit further comprises a voltage conversion circuit, wherein the voltage conversion circuit includes: a switching power supply, the switching power supply comprising an input end and an output end, wherein the input end of the switching power supply is configured to receive an input voltage. An inductive element, wherein one end of the inductive element is connected to the output end of the switching power supply, and the other end of the inductive element is configured as an output end of the voltage conversion circuit to generate an output voltage. And a capacitive element, wherein one end of the capacitive element is connected to a first node between the output end of the switching power supply and the inductive element, and the other end of the capacitive element is connected to a ground voltage to adjust a change rate of a voltage of the first node.

In some embodiments, the switching power supply includes: a first working branch connected between the input end and the output end of the switching power supply for transmitting the input voltage to the first node. A second working branch connected between the first node and the ground voltage for transmitting the ground voltage to the first node. And a control chip, configured to control a switch-on or switch-off operation of the first working branch and the second working branch.

In some embodiments, when the first working branch is switched on and the second working branch is switched off, the switching power supply outputs the input voltage. When the first working branch is switched off and the second working branch is switched on, the switching power supply outputs the ground voltage, wherein the control chip controls the first working branch and the second working branch to be switched on alternately at a switching frequency.

In some embodiments, the voltage conversion circuit further includes a feedback branch connected between the output end of the voltage conversion circuit and the switching power supply to feed back the output voltage of the output end of the voltage conversion circuit to the switching power supply.

In some embodiments, the switching power supply further includes a feedback end connected to the control chip and the feedback branch to feed back the output voltage to the control chip, thereby adjusting the switching frequency by the control chip.

In some embodiments, the first working branch includes: a first switch connected between the input end and the output end of the switching power supply, wherein the first switch is configured to receive a first control signal output by the control chip to realize a closing or an opening of the first switch, thereby controlling the first working branch to be switched on or switched off.

In some embodiments, a second node is formed between the first switch and the output end of the switching power supply, and the second working branch includes a second switch connected between the second node and the ground voltage. And the second working branch receives a second control signal output by the control chip to realize a closing or an opening of the second switch, thereby controlling the second working branch to be switched on or switched off.

In some embodiments, the voltage conversion circuit further includes a first filter circuit, the first filter circuit includes a first capacitor, and the first capacitor is connected between the input end of the switching power supply and the ground voltage.

In some embodiments, the voltage conversion circuit further includes a second filter circuit, the second filter circuit includes a second capacitor, and the second capacitor is connected between the output end of the switching power supply and the ground voltage.

One of the embodiments of the present disclosure also discloses an acoustic output device, the acoustic output device further includes an audio power amplifier circuit, and the audio power amplifier circuit includes: a control unit; an audio power amplifier connected to the control unit to receive a control signal from the control unit; and a feedback unit connected between the audio power amplifier and the control unit, wherein the feedback unit generates a corresponding feedback signal to the control unit based on an output of the audio power amplifier, so that the control unit controls the audio power amplifier based on the feedback signal.

In some embodiments, the audio power amplifier has an electrostatic protection function, the audio power amplifier includes an enable pin connected to the control unit to work after receiving an enable control signal from the control unit.

In some embodiments, when the audio power amplifier works normally, the feedback signal is in a first form. When the audio power amplifier triggers the electrostatic protection function and stops working, the feedback signal is in a second form, and the control unit excites the enable control signal to restart the audio power amplifier when the feedback signal is in the second form.

In some embodiments, the audio power amplifier outputs two output signals to a speaker to drive the speaker, the two output signals constitute a differential signal. The feedback unit includes: a first feedback branch, configured to receive and process a first output signal; a second feedback branch configured to receive and process a second output signal; and an integration branch connected to the first feedback branch and the second feedback branch, wherein the integration branch is configured to integrate two processed output signals to generate the feedback signal.

In some embodiments, a first node is formed between a first output end of the audio power amplifier and the speaker, and a second node is formed between a second output end of the audio power amplifier and the speaker, the first feedback branch includes: a first rectifying device connected between the first node and the integration branch to receive the first output signal and perform a first rectifying and filtering processing on the first output signal. The second feedback branch includes: a second rectifying device connected between the second node and the integration branch to receive the second output signal and perform a second rectifying and filtering processing on the second output signal.

In some embodiments, the integration branch includes: a wire, wherein one end of the wire is connected to the first feedback branch and the second feedback branch, and the other end of the wire is connected to the control unit to integrate the two processed output signals to generate the feedback signal.

In some embodiments, the integration branch includes a resistance, a first conductor and a second conductor, wherein one end of the resistance is connected to the first feedback branch and the second feedback branch through the first conductor, and the other end of the resistance is connected to the control unit through the second conductor to integrate the two processed output signals to generate the feedback signal.

In some embodiments, the first rectifier and the second rectifier are rectifier diodes, respectively.

In some embodiments, the first form has a first fluctuation based on an upper side and a lower side of a first predetermined voltage, and the second form has a second fluctuation based on a side of a second predetermined voltage, wherein the first predetermined voltage is greater than the second predetermined voltage, and an amplitude of the first fluctuation is much smaller than an amplitude of the second fluctuation.

### BRIEF DESCRIPTION OF THE DRAWINGS

The present disclosure is further illustrated in terms of exemplary embodiments. These exemplary embodiments are described in detail with reference to the drawings. These embodiments are not limited, in these embodiments, the same number denote the same structure, with:

FIG. 1 is a schematic diagram of an application scenario of a charging control system according to some embodiments of the disclosure;

FIG. 2 is an exemplary frame diagram of a charging control circuit according to some embodiments of the present disclosure;

FIG. 3 is a structural position diagram of a charging terminal and a detection terminal according to some embodiments of the present disclosure;

FIG. 4 is a structural diagram of a charging terminal and a detection terminal according to other embodiments of the present disclosure;

FIG. 5 is a schematic diagram of a distribution state of residual liquid according to some embodiments of the present disclosure;

FIG. 6 is a schematic diagram of a distribution state of residual liquid according to other embodiments of the present disclosure;

FIG. 7 is a schematic diagram of a distribution state of residual liquid according to other embodiments of the present disclosure;

FIG. 8 is an exemplary structural diagram of a shell of a charging control circuit according to some embodiments of the present disclosure;

FIG. 9 is an exemplary circuit diagram of a charging control circuit according to some embodiments of the present disclosure;

FIG. 10 is an exemplary circuit diagram of a charging control circuit according to some embodiments of the present disclosure;

FIG. 11 is an exemplary circuit diagram of a charging control circuit according to other embodiments of the present disclosure;

FIG. 12 is an exemplary circuit diagram of a charging control circuit according to other embodiments of the present disclosure;

FIG. 13 is an exemplary structural diagram of a microcontroller of a charging control circuit according to some embodiments of the present disclosure;

FIG. 14 is an exemplary circuit diagram of a charging control circuit according to other embodiments of the present disclosure;

FIG. 15 is an exemplary structural diagram of a charging line according to other embodiments of the present disclosure;

FIG. 16 is an exemplary structural diagram of a charging line according to other embodiments of the present disclosure;

FIG. 17 is an exemplary structural diagram of a charging line according to other embodiments of the present disclosure;

FIG. 18 is an exemplary structural diagram of a charging line according to other embodiments of the present disclosure;

FIG. 19 is an exemplary structural diagram of a charging line according to other embodiments of the present disclosure;

FIG. 20 is an exemplary structural diagram of a charging line according to other embodiments of the present disclosure;

FIG. 21 is an exemplary structural diagram of a charging line according to other embodiments of the present disclosure;

FIG. 22 is an exemplary structural diagram of a charging line according to other embodiments of the present disclosure;

FIG. 23 is an exemplary structural diagram of a voltage conversion circuit according to some embodiments of the present disclosure;

FIG. 24 is an exemplary circuit diagram of a voltage conversion circuit according to some embodiments of the present disclosure;

FIG. 25 is an exemplary circuit diagram of a voltage conversion circuit according to some embodiments of the present disclosure;

FIG. 26 is a schematic diagram of a voltage waveform of a first node according to some embodiments of the present disclosure;

FIG. 27 is an exemplary structural diagram of an audio power amplifier circuit according to some embodiments of the present disclosure;

FIG. 28 is a schematic diagram of a first waveform of a feedback signal according to some embodiments of the present disclosure;

FIG. 29 is a schematic diagram of a second waveform of a feedback signal according to some embodiments of the present disclosure;

FIG. 30 is an example structural diagram of an audio power amplifier circuit according to some embodiments of the present disclosure; and

FIG. 31 is an exemplary structural diagram of an audio power amplifier circuit according to other embodiments of the present disclosure.

### DETAILED DESCRIPTION

In order to more clearly illustrate the technical solutions related to the embodiments of the present disclosure, brief introduction of the drawings referred to the description of the embodiments is disposed below. Obviously, drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections or assemblies of different levels. However, words may be replaced by other expressions if they serve the same purpose.

As used in the disclosure and the appended claims, the singular forms “a,” “an,” and “the” include plural referents unless the content clearly dictates otherwise. Generally speaking, the terms “comprise” and “include” only imply that the clearly identified steps and elements are included, and these steps and elements do not constitute an exclusive list, and the method or apparatus may also include other steps or elements.

The flowcharts used in the present disclosure illustrate operations that systems implement according to some embodiments of the present disclosure. It should be understood that the preceding or following operations are not necessarily performed in the exact order. On the contrary, each step may be processed in reverse order or simultaneously. At the same time, other operations may also be added to these processes, and one or more operations may be removed from these process.

According to some embodiments of the present disclosure, a charging control may include one or more of a charging circuit, a detection circuit, a control circuit, a charging line, and a voltage conversion circuit. The charging control circuit may be applied to various electronic and electrical equipments (e.g., headphone devices, mobile phones, wearable devices, speakers, etc.) to perform voltage conversion, charging protection, residual liquid detection, etc., during a charging process of electronic and electrical equipments. For example, the charging circuit may include a first charging terminal and a second charging terminal. The first charging terminal and the second charging terminal may contact with the corresponding electrode terminals of an external device (e.g., a charger, a charging line, etc.) to generate a charging voltage difference, so as to realize the charging of wearable devices and/or rechargeable electronic devices. The detection circuit may include a detection terminal, at least part of which may be located between the first charging terminal and the second charging terminal. When there is residual liquid (e.g., sweat, rain, etc.) between the first charging terminal and the second charging terminal, the detection terminal is in liquid communication with the first charging terminal or the second charging terminal. At this time, the detection circuit may detect the voltage information (e.g., a voltage value, a voltage change value, etc.) of the detection terminal. The control circuit may be coupled to the charging circuit and the detection circuit respectively, and the control circuit may perform predetermined actions based on the charging voltage difference and/or voltage information, so as to realize the detection of the liquid resident on a wearable device and/or a rechargeable electronic device. For another example, the charging line may include a power interface, a signal transmission line, a charging interface, a current limiting device, and a voltage stabilizing device. The power interface is connected to the charging interface through the signal transmission line. By disposing the current limiting device and the voltage stabilizing device on the signal transmission line, a current through the charging interface and the voltage of the charging interface may be limited by using a current limiting function of the current limiting device and the voltage stabilizing function of the voltage stabilizing device, so as to realize the charging protection of the charging device or the charging interface during a charging process through the charging circuit. As another example, the voltage conversion circuit may include a switching power supply, an inductive element, and a capacitive element. The switching power supply comprises an input end and an output end, and the output end of the switching power supply is connected to one end of the inductive element to form a first node. Electromagnetic interference caused by fast voltage change rate of the first node in a process of a conversion between a network voltage and a working voltage may affect the sensitivity of a radio frequency reception of the electronic device. In some embodiments, a capacitive element may be arranged in the voltage conversion circuit, one end of the capacitive element may be connected to the first node, and the other end of the capacitive element may be connected to a ground voltage, so that the voltage change rate of the first node may be adjusted to reduce the electromagnetic interference caused by the fast voltage change rate at the first node, thereby improving the sensitivity of the radio frequency reception of the electronic device.

Some embodiments of the present disclosure also relates to an acoustic output device (e.g., a headphone device) including an audio control circuit. The audio control circuit may include a control unit, an audio power amplifier, and a feedback unit. The feedback unit may be connected between the audio power amplifier and the control unit. The feedback unit may convert an output of the audio power amplifier into a feedback signal and output the feedback signal to the control unit. The control unit may determine a working state of the audio power amplifier according to different forms of the feedback signal, and then output an enabling control signal according to the working state of the audio power amplifier. In some embodiments, the enable control signal may control a restart of the audio power amplifier to realize a self starting function of the audio power amplifier.

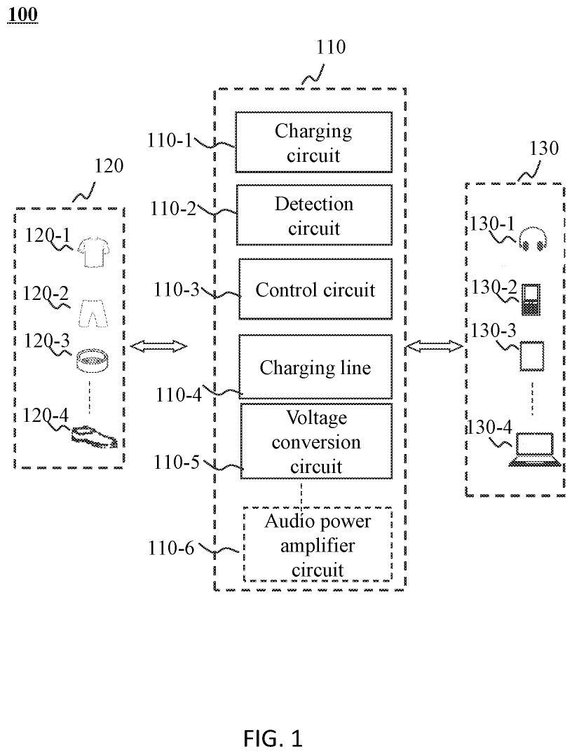

FIG. 1 is a schematic diagram of an application scenario of a charging control system according to some embodiments of the present disclosure. As shown in FIG. 1, the charging control system 100 may include a charging control circuit 110, a wearable device 120, and/or a rechargeable electronic device 130. In some embodiments, the charging control system 100 may detect residual liquid at a charging interface in the wearable device 120 and/or the rechargeable electronic device 130 and response to the residual liquid, so as to reduce the probability of electrolytic corrosion of the charging interface caused by a circuit caused by the residual liquid and the potential short circuit hazard of the wearable device 120 and/or the rechargeable electronic device 130. For example, when the wearable device 120 is charged, and when the charging control circuit 110 in the charging control system 100 detects the residual liquid (e.g., sweat, rain, etc.) on the wearable device 120, the charging control circuit 110 may send a warning signal through a control circuit 110-3 to prompt the user to perform processing operations, such as erasing the residual liquid. In some embodiments, the charging control system 100 may also implement charging protection for the wearable device 120 and/or the rechargeable electronic device 130. For example, when the user wears a headphone device 130-1, sweat may flow to the charging interface of the headphone device 130-1 through the human skin, resulting in a short circuit of the charging interface. When the charging interface is externally connected to a charging line for charging, a current of the short circuit is too large to burn the charging interface. The charging line 110-4 in the charging control system 100 may limit the current through the charging interface by setting a current limiting device on a signal transmission line to prevent the short circuit of the charging interface from causing excessive current in the charging interface, and further may prevent damage to the headphone device 130-1 connected to the charging interface or the charging interface itself. In some embodiments, the charging control system 100 may also improve a reception sensitivity of a radio frequency system of the chargeable electronic device 130. For example, when a DC-DC converter in the rechargeable electronic device 130 (e.g., the headphone device 130-1) converts a network voltage into a working voltage, an electromagnetic interference (EMI) generated by the too fast rate of voltage change will be coupled to the radio frequency system of the rechargeable electronic device 130, resulting in the degradation of reception sensitivity of radio frequency. The voltage conversion circuit 110-5 in the charging control system 100 may adjust the change rate of the voltage of the first node by setting a capacitive element between the first node and the ground voltage formed between the output end of the switching power supply and one end of the inductive element, so as to reduce the impact of the electromagnetic interference generated by the too fast change rate of the voltage of the first node on the reception sensitivity of radio frequency of the rechargeable electronic device 130.

In some embodiments, the charging control circuit 110 may include a charging circuit 110-1, a detection circuit 110-2, a control circuit 110-3, a charging line 110-4, a voltage conversion circuit 110-5, or the like, or any combination thereof. In some embodiments, the charging circuit 110-1 may be connected to the charging line 110-4 or an external device to generate a charging voltage difference. The charging circuit 110-1 may be coupled to the control circuit 110-3 for charging the wearable device 120 and/or the rechargeable electronic device 130. In some embodiments, the detection circuit 110-2 is disposed with a detection terminal, which is coupled with the control circuit 110-3, and the detection circuit 110-2 may be configured to detect the voltage value or voltage change value of the detection terminal. In some embodiments, the control circuit 110-3 may be configured to control whether the charging circuit 110-1 is charged or not, a charging duration, etc. The control circuit 110-3 may also be configured to receive and process signals such as voltages or voltage changes detected by the detection circuit 110-2, and perform a next step according to the processing results. In some embodiments, the charging line 110-4 may implement charging protection for the wearable device 120 and/or the rechargeable electronic device 130. In some embodiments, the voltage conversion circuit 110-5 may improve the reception sensitivity of the radio frequency system of the rechargeable electronic device 130.

In some embodiments, the charge control circuit 110 may be a single circuit or a combination of a plurality of circuits. For example, the charging control circuit 110 may be a combined circuit of the charging circuit 110-1, the detection circuit 110-2, and the control circuit 110-3, which can realize the detection of the residual liquid on the wearable device 120 and/or the rechargeable electronic device 130. For another example, the charging control circuit 110 may also be a single circuit of a voltage conversion circuit that can improve the reception sensitivity of the radio frequency system of the rechargeable electronic device 130. It should be noted that the circuit combination modes of the charging control circuit 110 may be various and are not limited here.

The wearable device 120 may refer to a garment or a device having a wearable function. In some embodiments, the wearable device 120 may include a coat device 120-1, a pants device 120-2, a wrist guard device 120-3, a shoes device 120-4, etc. In some embodiments, the coat device 120-1, the pants device 120-2, the wrist guard device 120-3, and the shoes device 120-4 may have electronic components that detect human physiological parameter information, a signal processing module, a signal transmission circuit, a power module, a mobile terminal, and the like that process human physiological parameters. In some embodiments, one or more of the charging control circuits 110 may be disposed in the coat device 120-1, the pants device 120-2, the wrist guard device 120-3, and the shoes device 120-4. For example, a charging line 110-4 may be disposed in the coat device 120-1, the pants device 120-2, the wrist guard device 120-3, and the shoes device 120-4 to reduce the possibility of damage due to excessive current during charging. In some embodiments, a charging circuit 110-1, a detection circuit 110-2, and a control circuit 110-3 may also be disposed in the coat device 120-1, the pants device 120-2, the wrist guard device 120-3, and the shoes device 120-4 to detect the residual liquid (e.g., sweat, rain, etc.) at the charging interface of the wearable device 120. It should be noted that the wearable device 120 is not limited to the coat device 120-1, the pants device 120-2, the wrist guard device 120-3, and the shoe device 120-4 shown in FIG. 1. The wearable device 120 may also be applied to other devices requiring charging, such as electronic watches, smart helmets, smart goggles, etc. Any devices that may use the charging control circuit 110 contained in the present disclosure is in the protection scope of the present disclosure.

In some embodiments, one or more of the charging control circuits 110 may be disposed in the chargeable electronic device 130. For example, a voltage conversion circuit 110-5 may be disposed in the chargeable electronic device 130 to improve the reception sensitivity of the radio frequency system of the chargeable electronic device 130. In some embodiments, the rechargeable electronic device 130 may include one or any combination of the headphone device 130-1, the mobile device 130-2, the tablet computer 130-3, the notebook computer 130-4, etc. In some embodiments, the mobile device 130-2 may include a mobile phone, a rechargeable smart home device, a rechargeable smart mobile device, a rechargeable virtual reality device, a rechargeable augmented reality device, or the like, or any combination thereof. In some embodiments, the rechargeable smart home device may include a control device of a smart appliance, an intelligent monitoring device, a smart TV, a smart camera, or the like, or any combination thereof. In some embodiments, the rechargeable intelligent mobile device may include a smart phone, a personal digital assistant (PDA), a game device, a navigation device, a POS device, or the like, or any combination thereof. In some embodiments, the rechargeable virtual reality device and/or the rechargeable augmented reality device may include a virtual reality helmet, virtual reality glasses, a virtual reality eye mask, an augmented reality helmet, augmented reality glasses, an augmented reality eye mask, or the like, or any combination thereof.

In some embodiments, the charging control circuit 110 may also include an audio power amplifier circuit 110-6 when the wearable device 120 and/or the rechargeable electronic device 130 (e.g., a headphone device 130-1) are devices having an audio playback function. In some embodiments, the audio power amplifier circuit 110-6 may implement a self starting function of the audio power amplifier. For example, the audio power amplifier in the headphone device 130-1 may be turned off due to the electrostatic protection function, so that the audio power amplifier may not output sound signals, and the headphone device 130-1 has a silent phenomenon. In this case, the charging control circuit 110 in the charging control system 100 may control a control unit to output an enable control signal to control the restart of the audio power amplifier, so as to realize the self starting function of the audio power amplifier.

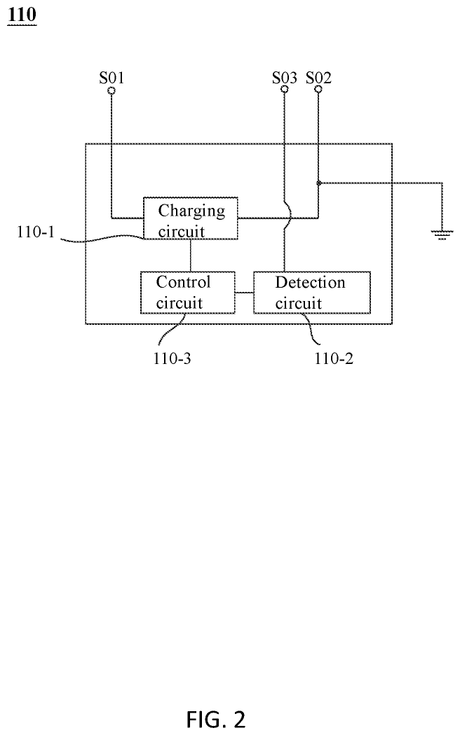

FIG. 2 is an exemplary frame diagram of a charging control circuit according to some embodiments of the present disclosure. As shown in FIG. 2, the charging control circuit 110 may include a charging circuit 110-1, a detection circuit 110-2, and a control circuit 110-3. The charging circuit 110-1 and the detection circuit 110-2 are coupled to the control circuit 110-3. The charging circuit 110-1 may be configured to be connected to the charging line 110-4 or an external device, and the charging circuit 110-1 generates a charging voltage difference after being connected to the charging line 110-4 or an external device. The external device here may be a device having power supply capability (e.g., a power supply device). In some embodiments, the charging circuit 110-1 may be configured to charge the wearable device 120 and/or the rechargeable electronic device 130. In some embodiments, the charging circuit 110-1 may also include a first charging terminal S01 and a second charging terminal S02. The first charging terminal S01 and the second charging terminal S02 may be configured to contact the corresponding electrode terminals of an external device (e.g., a charger, a charging line 110-4, etc.) to charge the wearable device 120 and/or the rechargeable electronic device 130.

The detection circuit 110-2 may include at least one detection terminal S03, and the detection circuit 110-2 may be configured to detect the voltage information of at least one detection terminal S03. In some embodiments, the voltage information may include at least a voltage value and/or a voltage change value (e.g., a difference between an actual voltage of the detection terminal S03 and a predetermined voltage) of the detection terminal S03. In some embodiments, the detection terminal S03 of the detection circuit 110-2 may be set independently of the first charging terminal S01 and the second charging terminal S02 of the charging circuit 110-1. It may be understood that when the first charging terminal S01 and the second charging terminal S02 are in contact with the corresponding electrode terminals of the external device, there is a charging voltage difference between the first charging terminal S01 and the second charging terminal S02, wherein the detection terminal S03 is not connected to the first charging terminal S01 and/or the second charging terminal S02, and there is no voltage information (e.g., voltage value, voltage change value) at the detection terminal S03. When there is liquid between the first charging terminal S01 and the second charging terminal S02 at the charging interface, the detection terminal S03 is connected to the first charging terminal S01 and/or the second charging terminal S02 through liquid. At this time, the detection circuit 110-2 may detect the voltage value and/or the voltage change value on the detection terminal S03.

The control circuit 110-3 may be configured to perform a predetermined action based on the charging voltage difference and voltage information. In some embodiments, performing a predetermined action based on the charging voltage difference and voltage information may include performing a predetermined action in response to the charging voltage difference and the voltage value and/or the voltage change value of the detection terminal satisfying a predetermined condition. For example, the control circuit 110-3 may control the charging circuit 110-1 to perform a charging action, a power-off action, etc., according to the predetermined condition. In some embodiments, the predetermined condition may include that the charging circuit generates a charging voltage difference, and the voltage value and/or voltage change value of the detection terminal is greater than the predetermined value. The predetermined value may be a predetermined voltage value or a predetermined voltage change value. For example, when the predetermined value is a voltage value, the predetermined value may be 20 mV, 30 mV, 110 MV, 200 mV, etc. For another example, when the predetermined value is a voltage change value, the predetermined value may be 20 mV, 30 mV, 110 mV, 200 mV, etc. It should be noted that the predetermined value here are not limited to the above values. The predetermined value may be adaptively adjusted according to the actual application scenarios. In some embodiments, the predetermined action may include that the control circuit 110-3 sends a control signal to the charging circuit 110-1 to stop charging the wearable device 120 and/or the rechargeable electronic device 130 through the first charging terminal S01 and the second charging terminal S02. For example, a circuit switch may be disposed between the first charging terminal S01 and/or the second charging terminal S02 and the charging circuit 110-1. The circuit switch may be configured to control a switch-on or switch-off operation between the first charging terminal S01 and/or the second charging terminal S02 and the charging circuit 110-1. When the charging voltage difference between the first charging terminal S01 and the second charging terminal S02 of the charging circuit 110-1 is generated, and the voltage value and/or voltage change value of the detection terminal S03 is greater than the predetermined value (e.g., 20 mV), the control circuit 110-3 may control the circuit switch to a disconnected state, thereby stopping charging. In some embodiments, the charging control circuit 110 may also include a switching circuit and other standby charging terminals (not shown in FIG. 2). The switching circuit may be configured to switch a connected state or a disconnected state between the first charging terminal S01, the second charging terminal S02 and other standby charging terminals and the charging circuit 110-1. In some embodiments, the predetermined action may also include that the control circuit 110-3 sends a control signal to the switching circuit to cut off the communication between the charging circuit 110-1 and the current charging terminal, and switches to other charging terminals for charging. For example, when the charging voltage difference between the first charging terminal S01 and the second charging terminal S02 of the charging circuit 110-1 is generated, and the voltage value and/or voltage change value of the detection terminal S03 is greater than a predetermined value (e.g., 20 mV), the control circuit 110-3 may send a control signal to control the switching circuit to convert the first charging terminal S01 and/or the second charging terminal S02 of the charging circuit 110-1 into a standby charging terminal, that is, the charging circuit 110-1 is disconnected from the first charging terminal S01 and/or the second charging terminal S02, and other charging terminals are configured to complete subsequent charging.

In some embodiments, the predetermined action may also include that the control circuit 110-3 sends an alarm signal to other circuits (e.g., a light-emitting circuit, a voice circuit) to issue an alarm indication. For example, the light-emitting circuit may include a light-emitting diode. When the charging circuit 110-1 is normally charged, a color of the light-emitting diode is green. When a charging voltage difference between the first charging terminal S01 and the second charging terminal S02 of the charging circuit 110-1 is generated, and the voltage value and/or voltage change value of the detection terminal S03 is greater than the predetermined value (e.g., 20 mV), the control circuit 110-3 may send an alarm signal to the light-emitting circuit, and the light-emitting diode may turn red.

In some embodiments, the charging control circuit 110 may also include a communication module, and the predetermined action may also include sending prompt information to the mobile terminal device in a wired or wireless manner through the communication module. In some embodiments, the prompt information may include one or more of text information, picture information, video information, voice information, etc. In some embodiments, the user may perform relevant operations through the corresponding alarm indications or prompt information, such as wiping off the residual liquid, so as to effectively reduce the corrosion caused by the electrolytic reaction caused by the liquid circuit and reduce the risk of circuit short circuit during charging.

In some embodiments, the charging control circuit 110 may also be disposed with a heating circuit, and a heating sheet may be disposed at the bottom of a charging slot. The control circuit 110-3 may be configured to send a drive signal to the heating circuit to dry the residual liquid. Due to the existence of charging voltage during the charging process, if liquid contacts the first charging terminal S01 and the second charging terminal S02 at the same time to form a circuit, the first charging terminal S01 and the second charging terminal S02 may act as electrodes to produce electrolytic reaction, resulting in corrosion of the first charging terminal S01 and the second charging terminal S02. In serious cases, it may lead to complete corrosion and failure to charge. In order to solve the above problem, in some embodiments, the rechargeable electronic device 130 may cause the detection circuit 110-2 to enter a detection state to detect voltage information (e.g., a voltage value, a voltage change value) only in a charged state. It may also be understood that when the chargeable electronic device 130 is not charged, the first charging terminal S01 and the second charging terminal S02 do not have a charging voltage difference, and the detection circuit 110-2 does not detect the voltage value or the voltage change value on the detection terminal S03. In other embodiments, the residual liquid may be detected by detecting a current or a change in current. The liquid on the detection terminal S03 may be more accurately detected by measuring the voltage value or the voltage change value on the detection terminal S03. In addition, since there is no need to install additional humidity sensors, etc., volumes of the rechargeable electronic and electrical equipment 130 may be effectively reduced.

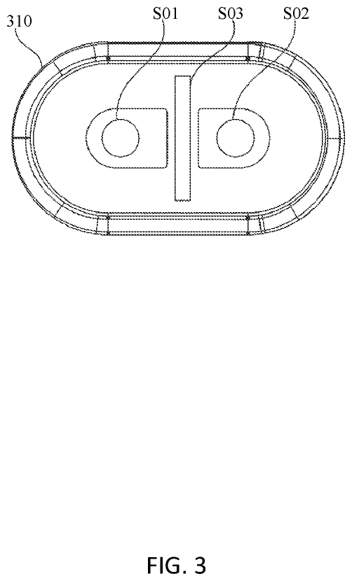

In order to prevent the short circuit caused by the contact between the first charging terminal S01 and the second charging terminal S02, there may be a certain distance between the first charging terminal S01 and the second charging terminal S02. In some embodiments, in order to facilitate monitoring of the first charging terminal S01 and the second charging terminal S02, at least a part of the detection terminal S03 may be located between the first charging terminal S01 and the second charging terminal S02. FIG. 3 is a schematic diagram of the structural positions of a charging terminal and a detection terminal according to some embodiments of the application. As shown in FIG. 3, the detection terminal S03 may be in a long strip shape, and at least part of the detection terminal S03 may be located on a connecting line between the first charging terminal S01 and the second charging terminal S02, and extend on the external surface of the shell 310 along a direction perpendicular to the connecting line. In some embodiments, the detection terminal S03 has a long strip shape and the long strip shape may separate the first charging terminal S01 and the second charging terminal S02. When liquid is located between the first charging terminal S01 and the second charging terminal S02, it may inevitably contact the detection terminal S03, so that the detection terminal S03 may be contaminated with liquid. In some embodiments, a distance between the detection terminal S03 and the first charging terminal S01 and a spacing between the detection terminal S03 and the second charging terminal S02 may be the same. In some embodiments, the distance between the detection terminal S03 and the first charging terminal S01 and the distance between the detection terminal S03 and the second charging terminal S02 may be different. For example, the distance between the detection terminal S03 and the first charging terminal S01 may be greater or less than the distance between the detection terminal S03 and the second charging terminal S02. In some embodiments, when the distance between the detection terminal S03 and the first charging terminal S01 and the distance between the detection terminal S03 and the second charging terminal S02 are different, the detection terminal S03 has a greater probability of communicating with the charging terminal closer to it. That is, the voltage at the detection terminal S03 may be closer to the charging terminal closer to it. In some embodiments, the detection terminal S03 may be placed directly between the first charging terminal S01 and the second charging terminal S02. In some embodiments, the detection terminal S03 may also be obliquely placed between the first charging terminal S01 and the second charging terminal S02. The oblique placement may be understood as that the detection terminal S03 forms a specific angle (e.g., 30°, 40°, 50°, 60°, etc.) with the connecting line of the first charging terminal S01 and the second charging terminal S02. In some embodiments, the structure of the detection terminal S03 is not limited to the strip structure shown in FIG. 3, and the detection terminal S03 may also be a structure of other shapes, such as a wavy structure, an arc structure, a ring structure, etc.

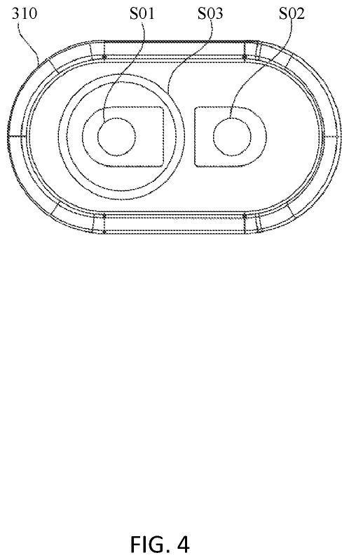

FIG. 4 is a structural diagram of a charging terminal and a detection terminal according to other embodiments of the present disclosure. As shown in FIG. 4, the detection terminal S03 may be a ring structure surrounding the first charging terminal S01 and/or the second charging terminal S02. When the detection terminal S03 is disposed as a ring structure, a larger detection range may be formed. Before the liquid diffuses to connect the first charging terminal S01 and the second charging terminal S02 to form a circuit, the detection terminal S03 may be contaminated with the liquid, and the corresponding voltage information may be detected through the detection circuit 110-2. In some embodiments, the detection terminal S03 may also be a structure of other closed shapes, e.g., regular or irregular shapes such as triangles, ellipses, and quadrilaterals. In some embodiments, the detection terminal S03 may also be an electrode structure that is not completely closed, such as a semicircle, a semi oval, a triangle with an opening, a quadrilateral, etc. In some embodiments, the first charging terminal S01 and/or the second charging terminal S02 may be located in a space region surrounded by the detection terminal S03. It should be noted that the shape, structure and distribution of the detection terminal S03 may be adjusted according to actual situations, as long as the detection terminal S03 may not be avoided when the liquid connects the first charging terminal S01 and the second charging terminal S02. In some embodiments, the electrode material of the detection terminal S03 may be one or more of a metal material, an alloy material, a carbon material, a metal oxide material, a ceramic material, or the like. In some embodiments, metallic materials may include nickel (Ni), iron (FE), titanium (TI), lead (PB), etc. In some embodiments, the alloy material may include one or more of a nickel zinc alloy, a platinum copper alloy, a platinum lead alloy, etc. In some embodiments, the carbon material may include graphite, glassy carbon, etc. In some embodiments, the metal oxide material may include one or more of manganese dioxide (MnO2), ruthenium dioxide (RuO2), lead dioxide (PbO2), nickel oxide (NiO), etc. In some embodiments, the ceramic material may include one or more of carbides, borides, nitrides, etc.

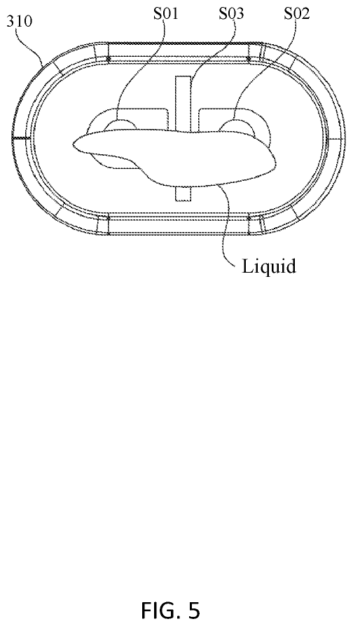

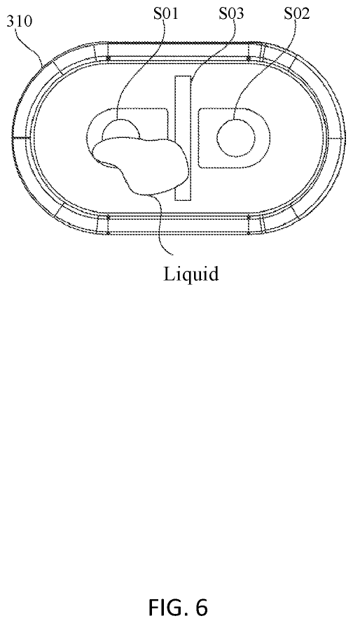

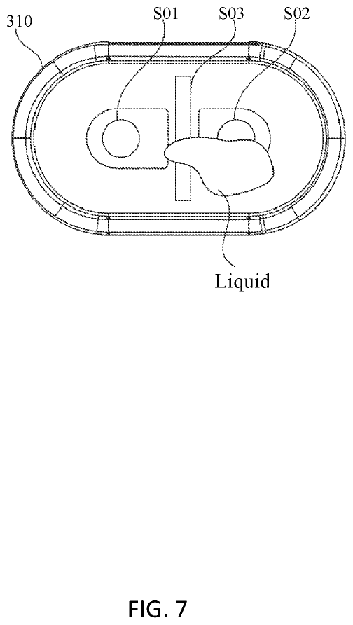

FIG. 5 is a schematic diagram of a distribution state of residual liquid according to some embodiments of the present disclosure. As shown in FIG. 5, when the liquid contacts the first charging terminal S01, the second charging terminal S02, and the detection terminal S03 at the same time, the first charging terminal S01, the second charging terminal S02 and the detection terminal S03 may form a circuit due to the charging voltage difference, and the detection terminal S03 may also have a certain potential in the circuit or form a potential change at the moment of conduction. Therefore, the detection circuit 110-2 may detect the voltage information on the detection terminal S03. In some embodiments, the distribution state of the residual liquid on the wearable device 120 and/or the rechargeable electronic device 130 is not limited to the first charging terminal S01, the second charging terminal S02 and the detection terminal S03 as shown in FIG. 5, but may also be distributed only on the detection terminal S03 and the first charging terminal S01, or only on the detection terminal S03 and the second charging terminal S02. For example, FIG. 6 is a schematic diagram of a distribution state of residual liquid according to other embodiments of the present disclosure. As shown in FIG. 6, the liquid may only contact the first charging terminal S01 and the detection terminal S03 at the same time. For another example, FIG. 7 is a schematic diagram of a distribution state of residual liquid according to other embodiments of the present disclosure. As shown in FIG. 7, the liquid may only contact the second charging terminal S02 and the detection terminal S03 at the same time. It should be noted that, regardless of the distribution of the liquid, as long as the liquid contacts the detection terminal S03 and other terminals (e.g., the first charging terminal S01 and the second charging terminal S02), so that the detection terminal S03 may generate voltage information, the detection circuit 110-2 may detect the voltage information and send the detected voltage information to the control circuit 110-3. The control circuit 110-3 may perform a predetermined action when the received voltage value or the received voltage change value meets a predetermined condition.

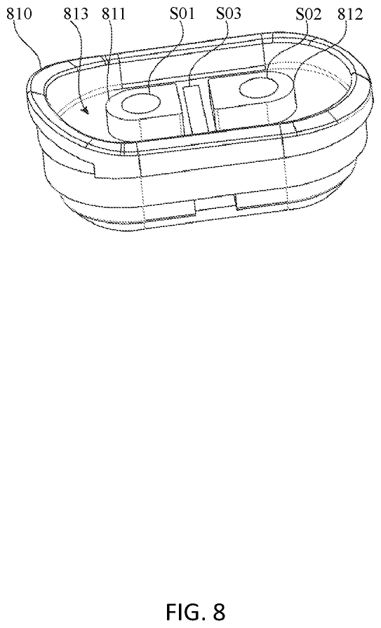

FIG. 8 is an exemplary structural diagram of a shell of a charging control circuit shown in some embodiments of the present disclosure. As shown in FIG. 8, the charging control circuit 110 may also include a shell 810, which may be configured to accommodate the charging circuit 110-1, the detection circuit 110-2, and the control circuit 110-3. In some embodiments, the external surface of the shell 810 may be disposed with a charging slot 813, and the charging slot 813 may be disposed with a first electrode seat 811 and a second electrode seat 812 which protrude from the bottom of the charging slot and are disposed at intervals. In some embodiments, the first charging terminal S01 and the second charging terminal S02 may be embedded in the first electrode seat 811 and the second electrode seat 812 respectively, and at least part of the detection terminal S03 may be located on the bottom surface of the charging slot between the first electrode seat 811 and the second electrode seat 812 and may be lower than the first charging terminal S01 and the second charging terminal S02. In some embodiments, the liquid may eventually contact the bottom of the charging slot 813 under the gravity, so the detection terminal S03 may be effectively contaminated with the liquid to obtain effective detection data. In some embodiments, the detection terminal S03 may be exposed to the external surface of the shell 810, and at least part of the detection terminal S03 may be located on the connecting line between the first charging terminal S01 and the second charging terminal S02, and extend on the external surface of the shell 810 along a direction perpendicular to the connecting line. In some embodiments, a material of the shell 810 may be plastic, light metal alloy, wood material, etc. In some embodiments, plastic may include polycarbonate (PC), thermoplastic polymer materials (e.g., ABS), etc. In some embodiments, light metal alloy may include aluminum alloys, nickel titanium alloys, etc. It should be noted that in some embodiments, the shell 810 may be an independent structure relative to the wearable device 120 and/or the rechargeable electronic device 130. For example, the shell 810 may be detachably connected to (e.g., snap in, plug-in, bonding, etc.) the wearable device 120 and/or the rechargeable electronic device 130. In some embodiments, the shell 810 may also be a partial structure of the wearable device 120 and/or the rechargeable electronic device 130, and the charging circuit 110-1, the detection circuit 110-2, and the control circuit 110-3 may be integrated in the wearable device 120 and/or the rechargeable electronic device 130.

In some embodiments, after the charging circuit 110-1 starts charging with the first charging terminal S01 and the second charging terminal S02, the detection circuit 110-2 may be triggered to detect whether the voltage value generated by the contaminated liquid on the detection terminal S03 is greater than the predetermined value (e.g., 20 mV), and may perform a predetermined action in response to detecting that the voltage value is greater than the predetermined value. It may be understood that before the charging circuit 110-1 starts charging and the detection terminal S03 is not contaminated with liquid, the detection circuit 110-2 may have no voltage and may not detect voltage. When the liquid diffuses from the first charging terminal S01 of the positive pole to the detection terminal S03, the detection terminal S03 is connected to the first charging terminal S01 of the positive pole. Therefore, the detection circuit 110-2 may detect that there is voltage on the detection terminal S03. When the liquid further diffuses from the detection terminal S03 to the second charging terminal S02 of the negative electrode, the detection circuit 110-2 may still detect that there is a voltage on the detection terminal S03. In some embodiments, the charging control circuit 110 may realize the charging function by plugging and matching the positive electrode terminal and the negative electrode terminal with an external device (e.g., a charging base, etc.). It may be understood that only when the liquid connects the first charging terminal S01 and the second charging terminal S02 may the electrolytic reaction be caused, and the liquid connecting the first charging terminal S01 and the second charging terminal S02 often exists between the first charging terminal S01 and the second charging terminal S02. Therefore, the detection terminal S03 is disposed between the first charging terminal S01 and the second charging terminal S02, it is possible to make it easier for the detection terminal S03 to simultaneously contact the liquid with the first charging terminal S01 and the second charging terminal S02, thereby generating a voltage value under the influence of the first charging terminal S01 or the second charging terminal S02.

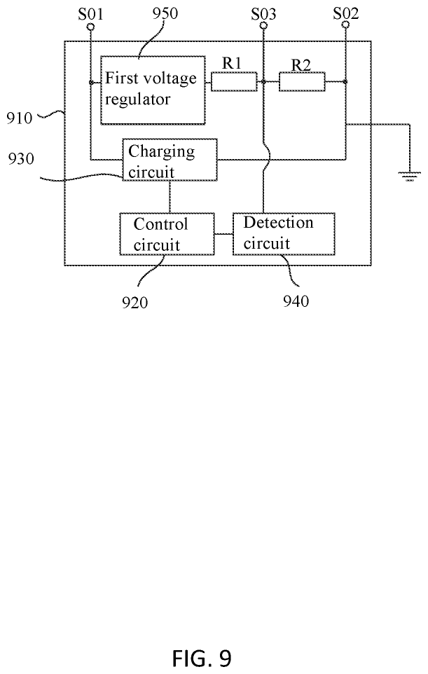

FIG. 9 is an exemplary circuit diagram of a charging control circuit according to some embodiments of the present disclosure. As shown in FIG. 9, in some embodiments, the charging control circuit 110 may include a shell 910, a control circuit 920, a charging circuit 930, a detection circuit 940, a first voltage regulator 950, a first voltage dividing resistor R1, and a second voltage dividing resistor R2. Descriptions regarding to the shell 910, the control circuit 920, the charging circuit 930, and the detection circuit 940 may have same as or similar with structures or principles of the charging circuit 110-1, the detection circuit 110-2, and the control circuit 110-3 described in FIG. 2 of the present disclosure. One end of the first voltage dividing resistor R1 may be connected to the first voltage regulator 950, the other end may be connected to the detection terminal S03 and one end of the second voltage dividing resistor R2, and the other end of the second voltage dividing resistor R2 is grounded. In some embodiments, the resistance values of the first voltage dividing resistor R1 and the second voltage dividing resistor R2 may be the same or different. Combined FIG. 2 and FIG. 9, in some embodiments, the first charging terminal S01 may be a positive electrode terminal, the second charging terminal S02 may be a negative electrode terminal, and the first voltage regulator 950 may be connected to the first charging terminal S01 for stabilizing and reducing the voltage from the first charging terminal S01 and outputting the voltage to the first voltage dividing resistor R1.

In some embodiments, after the charging circuit 110-1 starts to charge using the first charging terminal S01 and the second charging terminal S02, since the charging voltage is not a constant voltage, the charging voltage may be converted into a constant voltage through the first voltage regulator 950, which may be an LDO (low dropout regulator) or the like. In some embodiments, the first regulator 950 may also be another type of regulator capable of providing a constant voltage. In some embodiments, when there is no residual liquid, the detection circuit 110-2 may detect that there is a first voltage on the detection terminal S03 after the charging voltage passes through the first voltage regulator 950 and the first voltage dividing resistor R1. In practical use, the detection circuit 110-2 may detect whether the voltage change value (e.g., the difference between the real-time voltage value on S03 and the first voltage) on the detection terminal S03 is greater than a certain change threshold (e.g., 20 mV). If the voltage change value on the detection terminal S03 is greater than the change threshold, it indicates that the detection terminal S03 is contaminated with liquid and causes the detection terminal S03 to be connected to the first charging terminal S01 and/or the second charging terminal S02. At this time, the control circuit 920 may perform a predetermined action.

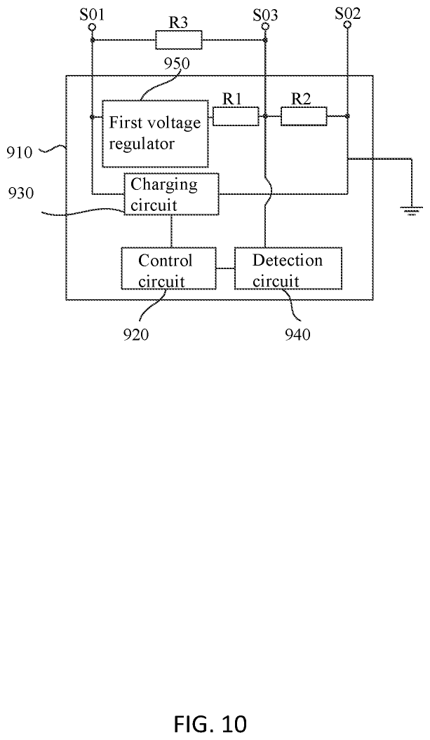

FIG. 10 is an exemplary circuit diagram of a charging control circuit according to some embodiments of the present disclosure. As shown in FIG. 10, the first charging terminal S01 and the second charging terminal S02 may be positive electrode terminals and negative electrode terminals, respectively. One end of the first voltage regulator 950 may be connected to the first charging terminal S01 for stabilizing and reducing the voltage from the first charging terminal S01 and outputting the voltage to the first voltage dividing resistor R1. One end of the second voltage dividing resistor R2 may be connected to the first voltage dividing resistor R1, the other end of the second voltage dividing resistor R2 may be connected to the second charging terminal S02, and the second charging terminal S02 may be grounded. In some embodiments, when the liquid contacts the first charging terminal S01 and the detection terminal S03 at the same time, the liquid may be approximately regarded as R3 with a certain resistance value. At this time, the resistance value between the first charging terminal S01 and the detection terminal S03 may be a parallel resistance of R3 and R1. In combination with FIG. 10, FIG. 9, and FIG. 2, the resistance value between the first charging terminal S01 and the detection terminal S03 may be changed, so the detection circuit 110-2 in FIG. 10 may detect that there is a second voltage (i.e., a real-time voltage value) on the detection terminal S03. If the voltage change value between the second voltage and the first voltage (i.e. the predetermined voltage) is greater than the predetermined value (e.g., 20 mV, 30 mV, 110 MV, 200 mV, etc.), the control circuit 110-3 may control other circuits to perform the predetermined action.

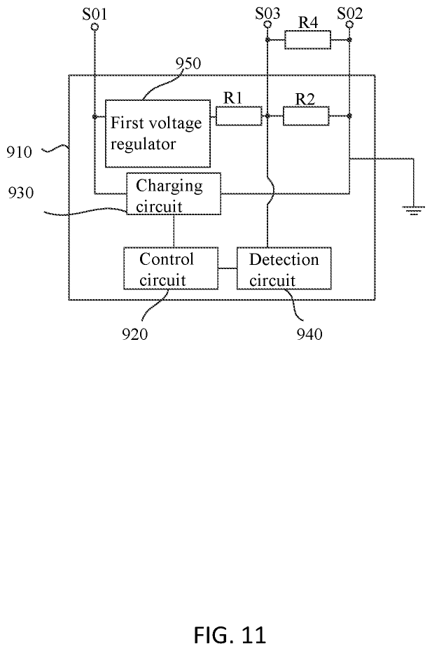

FIG. 11 is an exemplary circuit diagram of a charging control circuit according to other embodiments of the present disclosure. The circuit diagrams shown in FIG. 11 and FIG. 10 may be basically the same, with the difference that the liquid contacts the second charging terminal S02 and the detection terminal S03 at the same time. The liquid may be equivalent to R4 with a certain resistance value. At this time, the resistance value between the second charging terminal S02 and the detection terminal S03 may be a parallel resistance of R4 and R2. In combination with FIG. 11, FIG. 9, and FIG. 2, the resistance value between the second charging terminal S02 and the detection terminal S03 may be changed. Therefore, the detection circuit 110-2 in FIG. 11 may detect that there is a third voltage on the detection terminal S03. If the voltage change value between the third voltage and the first voltage is greater than the predetermined value (e.g., 20 mV, 30 mV, 110 MV, 200 mV, etc.), the control circuit 110-3 may control other circuits to perform the predetermined action.

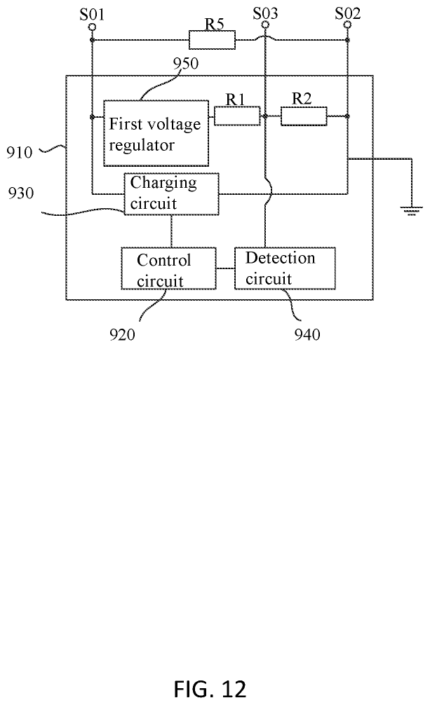

FIG. 12 is an example of the charging control circuit shown in the other embodiments in this application. The circuit diagrams shown in FIG. 12 and FIG. 11 may be basically the same, except that the liquid contacts the first charging terminal S01 and the second charging terminal S02 at the same time. The liquid may be equivalent to R5 with a certain resistance value. At this time, the resistance value between the first charging terminal S01 and the second charging terminal S02 may be a parallel resistance of R5 and a series resistor of R1 and R2. In combination with FIG. 12, FIG. 9, and FIG. 2, the resistance value between the first charging terminal S01 and the second charging terminal S02 may change, which may be equivalent to another voltage dividing resistance. Therefore, the detection circuit 110-2 in FIG. 11 may detect that there is a fourth voltage on the detection terminal S03. If the voltage change value between the fourth voltage and the first voltage is greater than the predetermined value (e.g., 20 mV, 30 mV, 110 MV, 200 mV, etc.), the control circuit 110-3 may control other circuits to perform predetermined actions.

It should be noted that the distribution state of residual liquid may be diverse, and more comprehensive detection of liquid may be realized through the voltage change value. In addition, disposing the voltage dividing resistance may protect the wearable device 120 and/or the rechargeable electronic device 130, and reduce the probability of damage to internal circuits due to excessive voltage when the liquid forms a circuit. In addition, details of controlling other circuits to perform predetermined actions through the control circuit 110-3 may be found elsewhere in the present disclosure (e.g., FIG. 2 and the descriptions thereof).

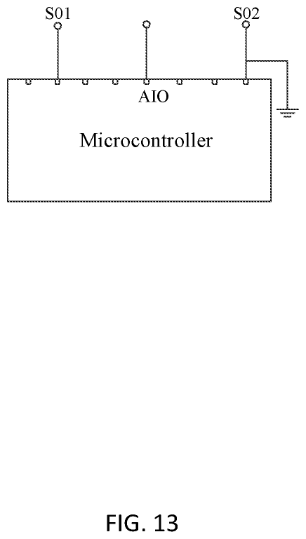

FIG. 13 is an exemplary structural diagram of a microcontroller of a charging control circuit according to some embodiments of the present disclosure. As shown in FIG. 13, in some embodiments, the control circuit 110-3 and the detection circuit 110-2 may be integrated into a microcontroller, and the detection terminal S03 may be connected to an analog input/output pin AIO port of the microcontroller. In some embodiments, the analog input/output pin AIO port may detect the voltage on the detection terminal S03. Accordingly, an output module may be connected to other pins of the microcontroller. In some embodiments, by integrating the control circuit 110-3 and the detection circuit 110-2, the volume of the wearable device 120 and/or the rechargeable electronic device 130 may be effectively reduced, and the wiring on the wearable device 120 and/or the rechargeable electronic device 130 may be reduced, thereby reducing power consumption of the wearable device 120 and/or the rechargeable electronic device 130.

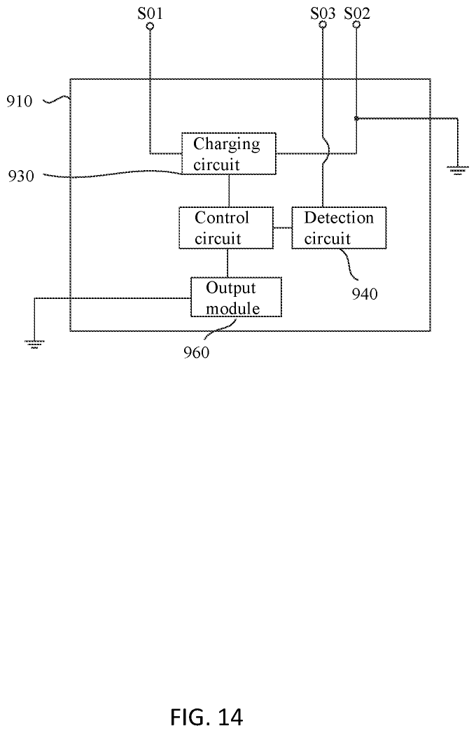

FIG. 14 is an exemplary circuit diagram of a charging control circuit according other embodiments of the present disclosure. As shown in FIG. 14, the charging control circuit 110 may also include an output module 960. In some embodiments, the output module 960 may include a buzzer, a light emitting body (e.g., a light emitting diode, etc.), a speaker, etc. In some embodiments, the output module 960 may be coupled to the control circuit 110-3, which may control the output module to perform predetermined actions based on the charging voltage difference and/or voltage information. For example, if the detection circuit 110-2 detects that there is a second voltage on the detection terminal S03, and the voltage change value between the second voltage and the first voltage is greater than the predetermined value (e.g., 20 mV, 30 mV, 110 mV, 200 mV, etc.), the control circuit 110-3 may control the buzzer to beep, the led to light, the speaker to emit a prompt tone or sends a prompt message to the user's mobile terminal equipment (e.g., a mobile phone, a smart watch) through the communication module. Through the above prompt method, the user may be prompted that liquid resides on the headphone device 130-1.

In some embodiments, when the charging circuit 110-1 is connected to an external power source to charge the chargeable electronic device 130, the current may be overload to burn the charging interface or the electronic components inside the chargeable electronic device 130. To solve the above problem, in some embodiments, the charging control circuit 110 may also include a charging line 110-4 capable of protecting the chargeable electronic device 130. For example, a current limiting device may be disposed on the signal transmission line of the charging line 110-4. When the current in the charging circuit 110-1 is overload during the charging process, the current limiting device (e.g., PTC thermistor) may reduce the current in the charging circuit 110-1 by increasing the resistance thereof, so as to protect the rechargeable electronic device 130 from being burned and realize the charging protection function.

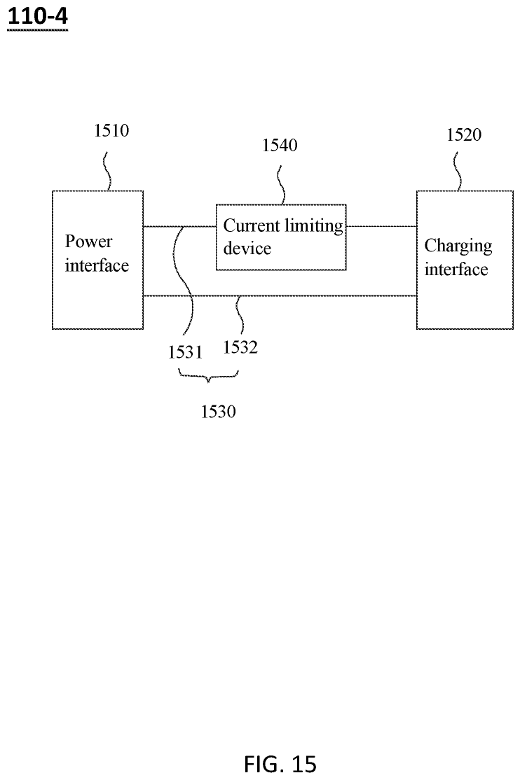

FIG. 15 is an exemplary structural diagram of a charging line according to other embodiments of the present disclosure. As shown in FIG. 15, the charging line 110-4 may include a power interface 1510, a charging interface 1520, a signal transmission line 1530, and a current limiting device 1540. In some embodiments, the power interface 1510 may be configured to connect the power adapter to receive the charging voltage, and the charging interface 1520 may be configured to connect the charging circuit 110-1, receive the charging voltage input through the power interface 1510 through the signal transmission line 1530, and output the charging voltage to the chargeable electronic device 130 to realize the charging of the chargeable electronic device 130. In some embodiments, the signal transmission line 1530 may be connected between the power interface 1510 and the charging interface 1520, and the signal transmission line 1530 may include a charging-voltage transmission line and a ground-voltage transmission line. The current limiting device 1540 may be connected to a charging-voltage transmission line for limiting the current through the charging interface 1520.

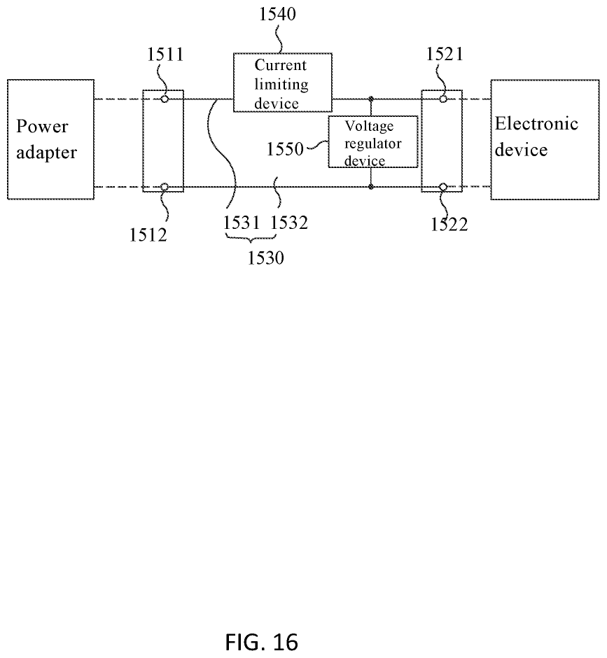

FIG. 16 is an exemplary structural diagram of a charging line according to other embodiments of the present disclosure. As shown in FIG. 16, the power interface 1510 may include a first end 1511 and a second end 1512. The charging interface 1520 may include a first end 1521 and a second end 1522. The signal transmission line 1530 may include a first transmission line 1531 and a second transmission line 1532. In some embodiments, the first end 1511 of the power interface 1510 may be connected to the first end 1521 of the charging interface 1520 through the first transmission line 1531, and the second end 1512 of the power interface 1510 may be connected to the second end 1522 of the charging interface 1520 through the second transmission line 1532. In some embodiments, the first end 1521 of the charging interface 1520 may be connected to the first charging terminal S01 of the charging circuit 110-1 shown in FIG. 2, and the second end 1522 of the charging interface 1520 may be connected to the second charging terminal S02 of the charging circuit 110-1 shown in FIG. 2 to charge the chargeable electronic device 130 and/or the wearable device 120.

In some embodiments, as shown in FIGS. 16-21, the first end 1511 of the power interface 1510 may be connected to the power pin of the interface of the power adapter to form a first power terminal, and the second end 1512 of the power interface 1510 may be configured as a ground terminal. In some embodiments, the first transmission line 1531 may be a charging-voltage transmission line, the first transmission line 1531 may be connected to the first end 1511 of the power interface 1510 and the first end 1521 of the charging interface 1520, and the first end 1521 of the charging interface 1520 may be a second power terminal of the charging interface 1520. In some embodiments, the second transmission line 1532 may be a ground-voltage transmission line, the second transmission line 1532 may be connected to the second end 1512 of the power interface 1510 and the second end 1522 of the charging interface 1520, and the second end 1522 of the charging interface 1520 may be a second ground terminal of the charging interface 1520. In some embodiments, when the second end 1512 of the power interface 1510 is connected to the power pin of the interface of the power adapter, the second end 1512 of the power interface 1510 may be a first power terminal of the power interface 1510, and the first end 1511 of the power interface 1510 may be a first ground terminal of the power interface 1510. In some embodiments, the second transmission line 1532 may be a charging-voltage transmission line. The second transmission line 1532 may be connected to the second end 1512 of the power interface 1510 and the second end 1522 of the charging interface 1520, and the second end 1522 of the charging interface 1520 may be the second power terminal of the charging interface 1520. In some embodiments, the first transmission line 1531 may be a ground-voltage transmission line, the first transmission line 1531 may be connected to the first end 1511 of the power interface 1510 and the first end 1521 of the charging interface 1520, and the first end 1521 of the charging interface 1520 may be the second ground terminal of the charging interface 1520.

As shown in FIG. 16, the charging line 110-4 may further include a current limiting device 1540. In some embodiments, the current limiting device 1540 may be connected to the first transmission line 1531 and may connect to the power interface 1510 and the charging interface 1520 through the first transmission line 1531 to limit the current through the charging interface 1520. In some embodiments, the charging line 110-4 may also include a voltage regulator device 1550 (also referred to as a second voltage regulator). The voltage regulator device 1550 may be connected between the first transmission line 1531 and the second transmission line 1532 to limit the charging voltage on the charging interface 1520.

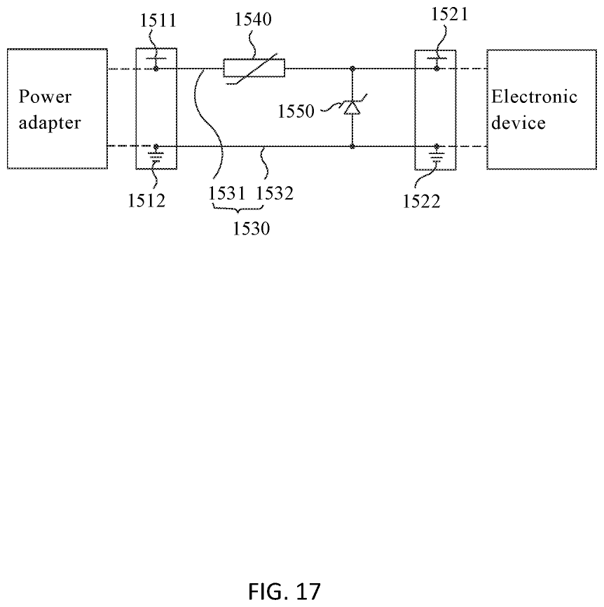

FIG. 17 is an exemplary structural diagram of a charging line according to other embodiments of the present disclosure. As shown in FIG. 17, in some embodiments, the current limiting device 1540 may be a self-adjusting resistor. The greater the current through the self-adjusting resistor is, the greater the resistance of the self-adjusting resistor is. In some embodiments, since the supply voltage is fixed, according to Ohm's law, the self-adjusting resistor may effectively reduce the current in the charging circuit by increasing its own resistance value. In some embodiments, the self-adjusting resistor may be a PTC (positive temperature coefficient) thermistor. When the charging circuit breakdowns and the current through the PTC thermistor is too large, the heating power of the PTC thermistor increases, resulting in an increase in the temperature of the PTC thermistor. In some embodiments, when the temperature of the PTC thermistor exceeds a switching temperature of the PTC thermistor, the resistance value of the PTC thermistor may be sharply increased, so that the current in the charging circuit may be rapidly reduced to a safe value to realize an overcurrent protection function. With the change of time, when the current returns to a rated working value, the resistance value of PTC thermistor gradually decreases to an initial rated value, so PTC thermistor may be reused as a smart fuse without replacement, which may effectively reduce the cost.

In some embodiments, the voltage regulator device 1550 may be a zener diode. The positive pole of the zener diode may be connected to the second transmission line 1532, and the negative pole of the zener diode may be connected to the first transmission line 1531. That is, the positive pole of the zener diode may be connected to the ground-voltage transmission line, and the negative pole of the zener diode may be connected to the charging-voltage transmission line. In some embodiments, when the charging voltage is too large or a surge impact is too strong, the zener diode may be turned on in reverse, the charging voltage input from the first power terminal of the power interface 1510 is successively output to the first ground terminal of the power interface 1510 or the second ground terminal of the charging interface 1520 through the charging-voltage transmission line and the zener diode. Therefore, the charging voltage may not be input into the wearable device 120 and/or the rechargeable electronic device 130 connected to the charging interface 1520, so that excessive charging voltage may be effectively prevented from burning the control chip or TVs (Transient Voltage Suppressor) tube inside the wearable device 120 and/or the rechargeable electronic device 130. In some embodiments, the voltage stabilizing diode may select a voltage stabilizing parameter of 5.6V, which may effectively protect the internal circuits of the wearable device 120 and/or the rechargeable electronic device 130 without exceeding the withstand voltage of the TVS tube and the control chip when the device may be normally powered. In some embodiments, when the first transmission line 1531 is a ground-voltage transmission line and the second transmission line 1532 is a charging-voltage transmission line, the positive pole of the zener diode may be connected to the first transmission line 1531 and the negative pole of the zener diode may be connected to the second transmission line 1532.

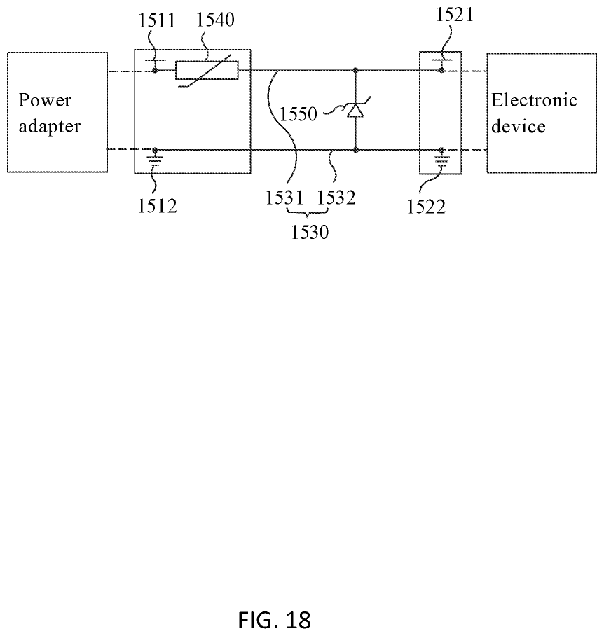

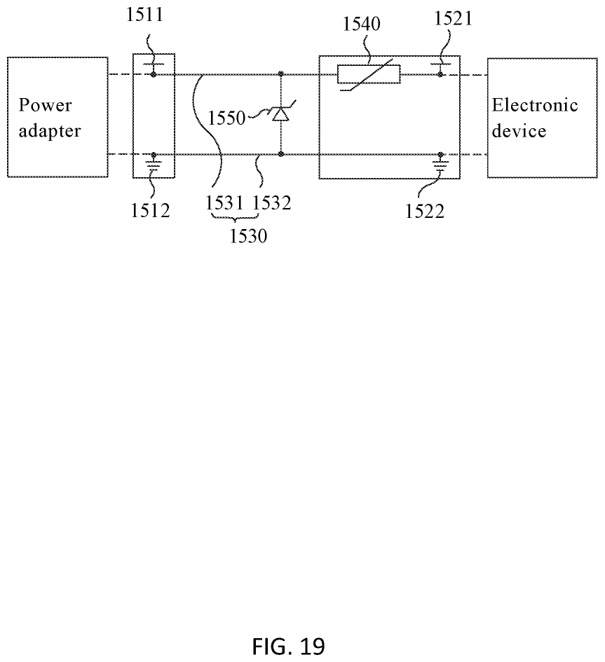

In some embodiments, both ends of the current limiting device 1540 may be respectively connected to the charging-voltage transmission line 1531. Here, it may be understood that the current limiting device 1540 is disposed in the signal transmission line 1530. In some embodiments, the current limiting device 1540 may also be disposed at other locations of the charging line 110-4. For example, FIG. 18 is an exemplary structural diagram of a charging line according to other embodiments of the present disclosure. As shown in FIG. 18, the current limiting device 1540 may be disposed in the power interface 1510. As another example, FIG. 19 is an exemplary structural diagram of a charging line according to other embodiments of the present disclosure. As shown in FIG. 19, the current limiting device 1540 may also be disposed in the charging interface 1520.

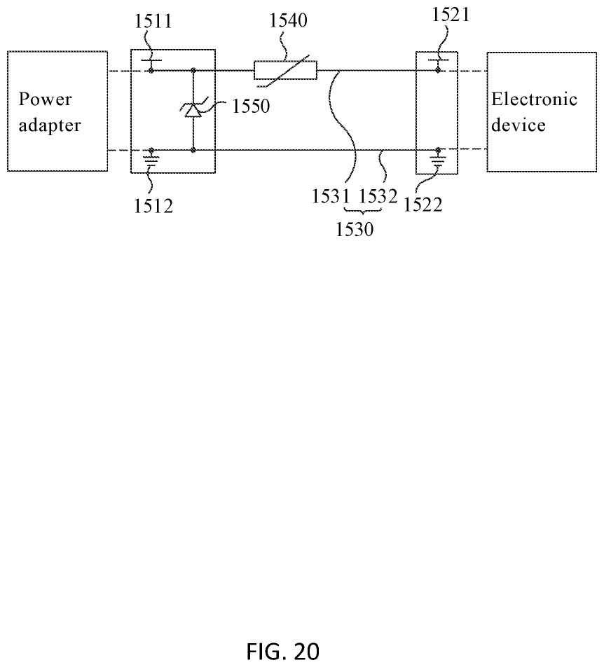

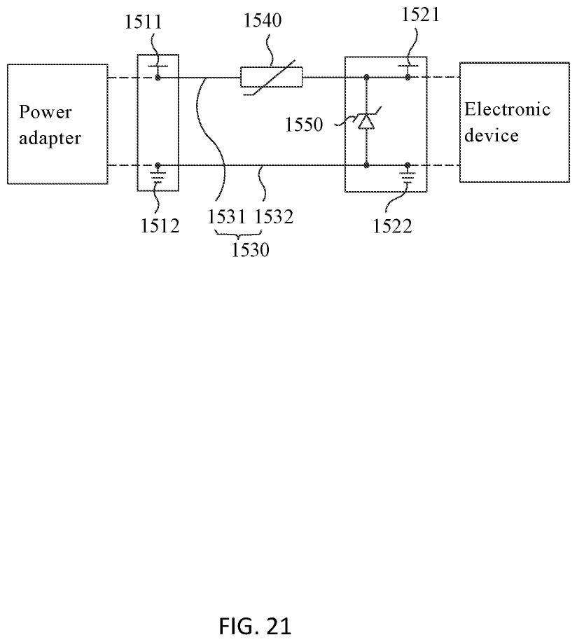

In some embodiments, the charging-voltage transmission line 1531 and the ground-voltage transmission line 1532 may be connected to both ends of the voltage regulator device 1550, respectively. Here, it may be understood that the voltage regulator device 1550 is disposed in the signal transmission line 1530. In some embodiments, the voltage regulator device 1550 may also be disposed at other locations of the charging line 110-4. For example, FIG. 20 is an exemplary structural diagram of a charging line according to other embodiments of the present disclosure. As shown in FIG. 20, the voltage regulator device 1550 may be disposed in the power interface 1510. As another example, FIG. 21 is an exemplary structural diagram of a charging line according to other embodiments of the present disclosure. As shown in FIG. 21, the voltage regulator device 1550 may also be disposed in the charging interface 1520.

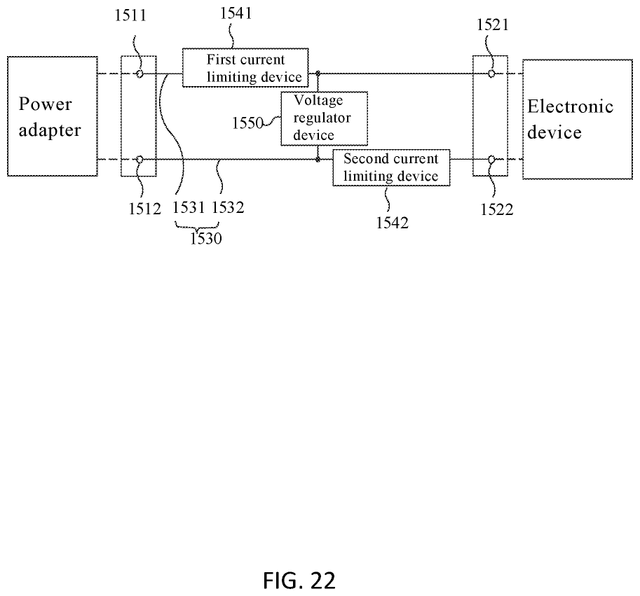

FIG. 22 is an exemplary structural diagram of a charging line according to other embodiments of the present disclosure. As shown in FIG. 22, the charging line 110-4 may include a plurality of current limiting devices. As an example only, the current limiting device may include a first current limiting device 1541 and a second current limiting device 1542. The first current limiting device 1541 may be connected to the charging-voltage transmission line 1531, and the second current limiting device 1542 may be connected to the ground-voltage transmission line 1532, that is, the two ends of the first current limiting device 1541 may be respectively connected to the first end 1511 of the power interface 1510 and the first end 1521 of the charging interface 1520 through the charging-voltage transmission line 1531. Both ends of the second current limiting device 1542 may be respectively connected to the second end 1512 of the power interface 1510 and the second end 1522 of the charging interface 1520 through the ground-voltage transmission line 1532. In some embodiments, the overcurrent protection function may be realized by the first current limiting device 1541 and the second current limiting device 1542, so that the overcurrent protection capability may be effectively improved.

It should be noted that the voltage regulator and current limiting device are not limited to one or two, but may also be multiple. When the voltage regulator and current limiting device are multiple, the voltage regulator and current limiting device may be located in the power interface 1510, the charging interface 1520, and/or the signal transmission line 1530. For example, both the voltage regulator device and the current limiting device may be disposed in the signal transmission line 1530. For another example, both the voltage regulator device and the current limiting device may be disposed in the power interface 1510. For another example, both the voltage regulator device and the current limiting device may be disposed in the charging interface 1520. For another example, the voltage regulator device and the current limiting device may also be disposed in the power interface 1510, the signal transmission line 1530, and the charging interface 1520, respectively. The position distribution of voltage regulator and current limiting device may be adjusted adaptively according to the actual situation.

In some embodiments, the charging line 110-4 may be disposed with a current limiting device 1540 and a voltage regulator device 1550 on the signal transmission line 1530. A current limiting function of the current limiting device 1540 and the voltage stabilizing function of the voltage regulator device 1550 may be used to limit the current through the charging interface 1520 and the voltage on the charging interface 1520. When the charging voltage is too large or the surge impact is too strong, the zener diode may be turned on in reverse, and the charging voltage may output to the first ground terminal of the power interface 1510 or the second ground terminal of the charging interface 1520, so that the charging voltage may not be input into the wearable device 120 and/or the rechargeable electronic device 130 connected to the charging interface 1520, and effectively prevent excessive charging voltage from burning the control chip or TVS tube inside the wearable device 120 and/or the rechargeable electronic device 130. Further, when the current in the charging circuit is too large due to excessive voltage, the PTC thermistor may reduce the current in the charging circuit by increasing the resistance. At the same time, when the charging interface 1520 of the wearable device 120 and/or the rechargeable electronic device 130 is short circuited due to liquid residue, the PTC thermistor may increase the resistance, which may prevent the charging interface 1520 from being short circuited, resulting in excessive current through the charging interface 1520, thereby preventing damage to the wearable device 120 and/or the rechargeable electronic device 130 connected to the charging interface 1520 or the charging interface 1520.

In some embodiments, when the chargeable electronic device 130 is charged through the charging line 110-4 in the charging control circuit 110, the DC-DC converter in the chargeable electronic device 130 may generate electromagnetic interference when the voltage changes too fast during the process of converting the network voltage into the working voltage, and the electromagnetic interference may be coupled to the radio frequency system of the chargeable electronic device 130 through a certain way, causing degradation of reception sensitivity. In order to solve the above problems, in some embodiments, the charging control circuit 110 may also include a voltage conversion circuit 110-5, which may be configured to reduce the influence of electromagnetic interference on the reception sensitivity of radio frequency of the chargeable electronic device 130 (e.g., a headphone) and improve the reception sensitivity of radio frequency of the chargeable electronic device 130. Descriptions of the voltage conversion circuit 110-5 may be found elsewhere in the present disclosure.

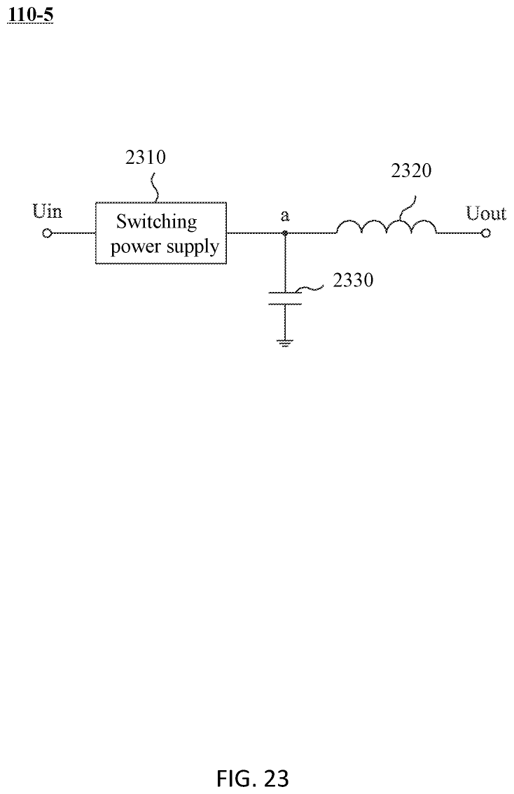

FIG. 23 is an exemplary structural diagram of a voltage conversion circuit according to some embodiments of the present disclosure. As shown in FIG. 23, the voltage conversion circuit 110-5 may include a switching power supply 2310, an inductive element 2320, and a capacitive element 2330. In some embodiments, the switching power supply 2310 may include an input terminal and an output terminal. The input terminal of the switching power supply 2310 may be connected to the input terminal of the voltage conversion circuit 110-5 for receiving an input voltage. In some embodiments, one end of the inductive element 2320 may be connected to the output end of the switching power supply 2310, and the other end of the inductive element 2320 may be connected to the output end of the voltage conversion circuit 110-5 to generate an output voltage. In some embodiments, the output end of the voltage conversion circuit 110-5 may be electrically connected to the power interface 1510 of the charging line 110-4. The voltage conversion circuit 110-5 may first convert the voltage of the power supply, and the current may be transmitted to the charging circuit 110-1 through the charging line 110-4, thereby completing the voltage conversion, current limitation and liquid detection during charging of the chargeable electronic device 130. In some embodiments, the input of the voltage conversion circuit 110-5 may also be electrically connected to the charging interface 1520 of the charging line 110-4. In some embodiments, the voltage conversion circuit 110-5 may also be located in the charging line 110-4. For example, the voltage conversion circuit 110-5 may be part of the signal transmission line 1530. It should be noted that the position of the voltage conversion circuit 110-5 is not limited to the above embodiments, but may also be located in other positions of the charging control circuit or inside the electronic device, which may realize the voltage conversion of the electronic device during the charging process, and is not further limited here. In some embodiments, a first node a may be formed between the output end of the switching power supply 2310 and one end of the inductive element 2320, one end of the capacitive element 2330 may be connected to the first node a, and the other end of the capacitive element 2330 may be connected to the ground voltage to adjust the change rate of the voltage of the first node a.

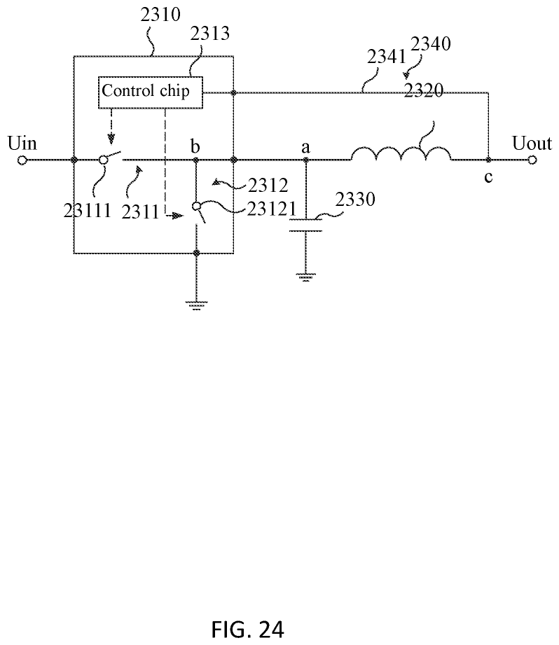

FIG. 24 is an exemplary circuit diagram of a voltage conversion circuit according to some embodiments of the present disclosure. As shown in FIG. 24, the switching power supply 2310 may include a first working branch 2311, a second working branch 2312, and a control chip 2313. In some embodiments, the first operating branch 2311 may be connected between the input and output terminals of the switching power supply 2310 for transmitting the input voltage to the first node a. The second operating branch 2312 may be connected between the first node a and the ground voltage for transmitting the ground voltage to the first node a. In some embodiments, the control chip 2313 may be coupled to the first working branch 2311 and the second working branch 2312. By sending the first control signal and the second control signal to the first working branch 2311 and the second working branch 2312, respectively, the control chip 2313 may control the first working branch 2311 and the second working branch 2312 to turn on or off, and then control the output voltage of the switching power supply 2310. The first control signal and the second control signal may be PWM (Pulse Width Modulation) signals. PWM modulation may have high efficiency and may have the effect of reducing ripple and noise of the output voltage.

In some embodiments, the first working branch 2311 may include a first switch 23111, which may be connected between the input and output terminals of the switching power supply 2310, receive the first control signal output by the control chip 2313 to realize the closing and opening of the first switch 23111, and then control the turning on or off of the first working branch 2311. In some embodiments, a second node b may be formed between the first switch 23111 and the output end of the switching power supply 2310, the second working branch 2312 may include a second switch 23121, the second switch 23121 may be connected between the second node b and the ground voltage, and receive the second control signal output by the control chip 2313 to realize the closing and opening of the second switch 23121, so as to control the turning on or off of the second working branch 2312.

In some embodiments, the voltage conversion circuit 110-5 may also include a feedback branch 2340, which may be connected between the output end of the voltage conversion circuit 110-5 and the switching power supply 2310 to feed back the output voltage of the output end to the switching power supply 2310. In some embodiments, the switching power supply 2310 may further include a feedback terminal, which may be connected to the control chip 2313 and the feedback branch 2340 to feed back the output voltage to the control chip 2313 so that the control chip 2313 may adjust the switching frequency. Alternatively, a third node c may be formed between the inductive element 2320 and the output end of the voltage conversion circuit 110-5, the feedback branch 2340 may include a wire 2341, one end of the wire 2341 may be connected to the third node c, and the other end of the wire 2341 may be connected to the feedback end of the switching power supply 2310 to transmit the output voltage of the output end to the feedback end, and then to the control chip 2313. In some embodiments, the feedback branch 2340 may also be disposed with components such as resistors or capacitors, for example, a single resistor, a single capacitor, a combination of resistors and capacitors, etc.

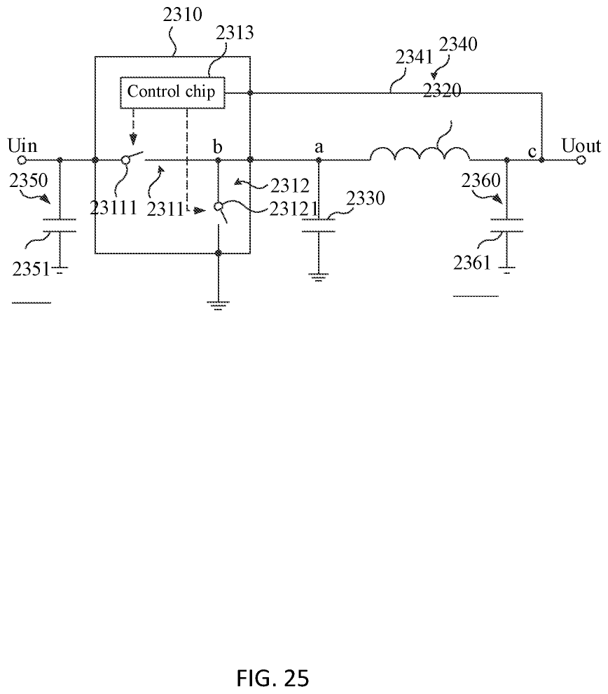

FIG. 25 is an exemplary circuit diagram of a voltage conversion circuit according to some embodiments of the present disclosure. As shown in FIG. 25, the voltage conversion circuit 110-5 may further include a first filter circuit 2350, which may include a first capacitor 2351, which may be connected between the input terminal of the voltage conversion circuit 110-5 and the ground voltage. In some embodiments, the first filter circuit 2350 may be configured to prevent the on-off process of the first switch 23111 and the second switch 23121 from affecting the input of the voltage conversion circuit 110-5, thereby affecting the external circuit. At the same time, the first filter circuit 2350 may also filter the interference of the external circuit to the voltage conversion circuit 110-5. In some embodiments, the voltage conversion circuit 110-5 may further include a second filter circuit 2360, which may include a second capacitor 2361, which may be connected between the output of the voltage conversion circuit 110-5 and the ground voltage. In some embodiments, the second filter circuit 2360 may be configured to filter, stabilize and store energy for the output voltage of the voltage conversion circuit 110-5 to ensure that the output voltage is constant. In some embodiments, the first filter circuit 2350 and the second filter circuit 2360 may be one of an RC filter circuit, an RL filter circuit, an RLC filter circuit, etc.

In some embodiments, the capacitive element 2330 connected between the first node a and the ground voltage may be disposed to adjust (e.g., reduce) the voltage change rate of the first node a, so as to reduce the electromagnetic interference generated by the rapid voltage change of the first node a, reduce the impact of electromagnetic interference on the RF reception of the chargeable electronic device 130, and improve the reception sensitivity of RF of the chargeable electronic device 130. Specifically, the voltage change rate of the first node a is related to the capacitance value of the capacitive element 2330 between the first node a and the ground voltage. For example, in a certain range, the greater the capacitance value of capacitive element 2330 is, the stronger the ability of capacitive element 2330 to supplement voltage is, the smaller the voltage change rate of first node a is, and the stronger the ability to reduce electromagnetic interference is. The capacitive element 2330 may refer to an element for storing electric charges. As an example only, the capacitive element 2330 may include a first electrode plate and a second electrode plate, wherein a dielectric material is disposed between the first electrode plate and the second electrode plate. When the first electrode plate and the second electrode plate are electrically connected to the first node a and the ground voltage, respectively, the first electrode plate and the second electrode plate may store or release positive and negative charges, thereby preventing the voltage of the first node a from changing too fast. In some embodiments, the capacitance of the capacitive element 2330 is positively correlated with the relative dielectric constant of the dielectric material and the positive opposite areas of the first electrode plate and the second electrode plate, and the capacitance of the capacitive element 2330 is negatively correlated with the spacing between the first electrode plate and the second electrode plate. The capacitance value of the capacitive element 2330 may be adjusted by adjusting the relative dielectric constant of the dielectric material, the opposite area of the first electrode plate and the second electrode plate, or the distance between the first electrode plate and the second electrode plate. In some embodiments, the input end of the voltage conversion circuit 110-5 is disposed with a first filter circuit 2350, which can prevent the on-off process of the first switch 23111 and the second switch 23121 from affecting the input end of the voltage conversion circuit 110-5, thereby affecting the external circuit, and filter the interference of the external circuit to the voltage conversion circuit 110-5. In addition, the output end of the voltage conversion circuit 110-5 is disposed with a second filter circuit 2360, which may filter, stabilize and store energy for the output voltage of the voltage conversion circuit 110-5 to ensure that the output voltage is constant.

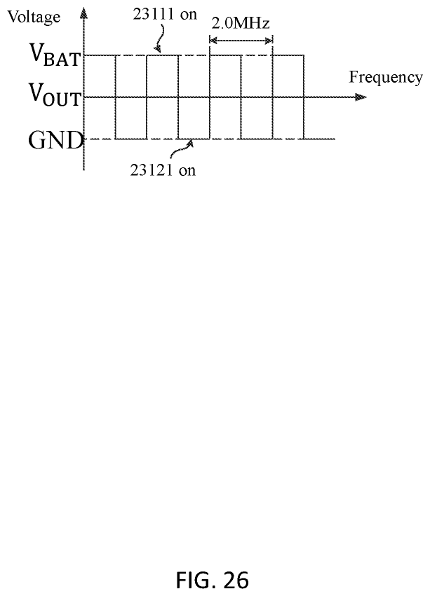

FIG. 26 is a schematic diagram of a voltage waveform of a first node according to some embodiments of the present disclosure. As shown in FIG. 26, the abscissa may represent the frequency and the ordinate may represent the output voltage of the switching power supply 2310. In some embodiments, when the first working branch 2311 is switched and the second working branch 2312 is switched off, that is, when the first switch 23111 is closed and the second switch 23121 is turned off, the switching power supply 2310 may output an input voltage. The first working branch 2311 is switched off and the second working branch 2312 is switched on, that is, when the first switch 23111 is turned off and the second switch 23121 is closed, the switching power supply 2310 may output the ground voltage GND. The control chip 2313 controls the first working branch 2311 and the second working branch 2312 to conduct alternately at the switching frequency, so that the switching power supply 2310 alternately outputs the input voltage and the ground voltage GND, so that the voltage waveform of the first node a is shown in FIG. 26. In some embodiments, the frequency at which the first node a receives the primary input voltage and the primary ground voltage GND is 2.0 MHz, that is, the frequency at which the primary periodic voltage change is achieved as 2.0 MHz. In some embodiments, the switching frequency may be a frequency that achieves a periodic voltage change, and the switching frequency may be 2.0 MHz. It should be noted that the switching frequency is determined by the main control chip of the voltage conversion circuit 110-5, and the switching frequency is associated with specific parameters (e.g., capacitance value, impedance) of capacitive or inductive elements. Taking the capacitive element as an example, the equivalent impedance (also known as the capacitive reactance value) of the capacitive element 2330 is ½πfc, where f is the voltage change frequency (i.e. switching frequency), C is the capacitance value. The equivalent impedance of the capacitive element 2330 cannot be too small, that is, the equivalent impedance of the capacitive element 2330 cannot be less than a certain impedance threshold, so as to avoid the problem that the capacitive element 2330 may flow a relatively large current and cause too high power consumption of the system. When the capacitance value of the capacitive element 2330 is constant, the switching frequency should be less than a certain frequency threshold, so that the equivalent impedance of the capacitive element 2330 is greater than or equal to the impedance threshold.

In some embodiments, the voltage conversion circuit 110-5 may be applied to the rechargeable electronic device 130. Here, the headphone device 130-1 is taken as an example. The operating frequency band of the headphone device 130-1 is 2.4 GHz-2.5 GHz, and the reception sensitivity of the bluetooth master chip of the headphone device 130-1 may be −98 dB under fixed conditions. In some embodiments, the too fast rate of voltage change during the conversion of the voltage conversion circuit 110-5 may generate electromagnetic interference, which may be coupled to the radio frequency system of the headphone device 130-1 through a certain way, resulting in the reduction of reception sensitivity of RF. In some embodiments, the voltage conversion circuit 110-5 may add a capacitive element 2330, and the rate of change of the voltage of the first node a may be adjusted (e.g., reduced) by adding a capacitive element 2330 connected between the first node a and the ground voltage. In some embodiments, the voltage change rate may be the ratio of the amount of voltage change to time. When the amount of voltage change is the same, increasing the time corresponding to the voltage change may reduce the voltage change rate. In some embodiments, by adjusting the change rate of the voltage of the first node a, that is, by changing the slope of the rising or falling edge of the voltage of the first node a, the time for the voltage of the first node a to change from GND or GND may be increased, so that the electromagnetic interference generated by the rapid change of the voltage of the first node a may be reduced, and then the electromagnetic interference generated may be prevented from affecting the communication signal of the rechargeable electronic device 130, For example, the headphone device 130-1 performs a wireless signal transmitted by bluetooth.

In some embodiments, the reception sensitivity of the headphone device 130-1 before the capacitive element 2330 is disposed in the voltage conversion circuit 110-5 may be −85 dB, and the reception sensitivity after the capacitive element 2330 is disposed in the voltage conversion circuit 110-5 may be −88 dB, that is, the voltage conversion circuit 110-5 may reduce the interference signal by 3 dB after the capacitive element 2330 is disposed, thereby improving the reception sensitivity of the headphone device 130-1. It should be noted that the voltage conversion circuit 110-5 may be applied to other electronic devices (e.g., mobile phones, computers, iPads, speakers, etc.) in addition to the headphone device 130-1. For example, when the voltage conversion circuit 110-5 is applied to a mobile phone, the front reception sensitivity of RF of the mobile phone may be improved.

In some embodiments, the switching power supply 2310 may also be composed of other discrete devices, such as a control chip, an inductive coil, a diode, a triode, a capacitor, etc. In some embodiments, the inductive element 2320 may be an inductor, and the energy stored by the inductor can ensure that the output voltage at its output terminal is constant. In some embodiments, the capacitive element 2330 may be a capacitor, the capacitance value range of the capacitive element 2330 may be 5 PF-500 PF, and the capacitance value of the capacitive element 2330 may be selected according to the switching frequency of the switching power supply 2310. In some embodiments, the capacitance value of the capacitive element 2330 may be 10 PF, 50 PF, 100 PF, etc.

The embodiment of the present disclosure also provides an acoustic output device. The acoustic output device may be an electronic device having an audio playback function. The acoustic output device (e.g., the headphone device 130-1) may include one or more of the charging control circuit 110, for example, one or more of the charging circuit 110-1, the detection circuit 110-2, the control circuit 110-3, the charging line 110-4, the voltage conversion circuit 110-5, etc. In some embodiments, the acoustic output device may include a headphone (e.g., a bone conduction headphone, an air conduction headphone), a speaker device, a mobile phone, a computer, an MP3, or the like, or any combination thereof. Taking headphone (e.g., headphone device 130-1) as an example, headphone usually use audio power amplifier of class D as headphone power amplifier, while audio power amplifier of class D needs EMI test to realize the electrostatic protection function. When audio power amplifier of class D is actually used in headphone equipment, static electricity may easily cause audio power amplifier of class D to trigger the electrostatic protection function, turn off the audio power amplifier of class D, so that audio power amplifier of class D has no output and the headphone is silent. At this time, the user needs to manually restart the headphone to enable the audio power amplifier of class D to work again. In order to solve the above problem, in some embodiments, the acoustic output device may also include an audio power amplifier circuit 110-6 having an automatic restart function.

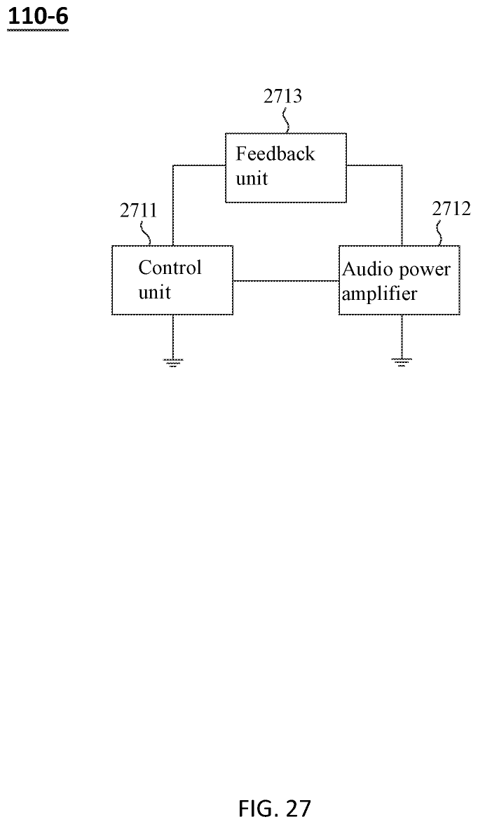

FIG. 27 is an exemplary structural diagram of an audio power amplifier circuit according to some embodiments of the present disclosure. As shown in FIG. 27, the audio power amplifier circuit 110-6 may include a control unit 2711, an audio power amplifier 2712, and a feedback unit 2713. In some embodiments, the audio power amplifier 2712 may be connected to the control unit 2711 to receive a control signal from the control unit 2711. The feedback unit 2713 may be connected between the audio power amplifier 2712 and the control unit 2711, and generates a corresponding feedback signal to the control unit 2711 according to the output of the audio power amplifier 2712, so that the control unit 2711 may control the audio power amplifier 2712 according to the feedback signal. In some embodiments, the input of the feedback unit 2713 may be connected to the output of the audio power amplifier 2712, the output of the feedback unit 2713 may be connected to the input of the control unit 2711, and the output of the control unit 2711 may be connected to the input of the audio power amplifier 2712.

In some embodiments, the input end of the audio power amplifier 2712 may include an enable pin and a data pin data, the output end of the control unit 2711 may include an enable output end and a data output end, and the data pin data of the audio power amplifier 2712 may be configured to connect the data output end of the control unit 2711 for receiving the data output from the control unit 2711. In some embodiments, the enable pin of the audio power amplifier 2712 may be configured to connect the enable output of the control unit 2711 to receive the enable control signal sent by the control unit 2711 according to the feedback signal. In some embodiments, the audio power amplifier 2712 may further include a ground terminal for discharging static electricity to ground. The control unit 2711 may further include a ground terminal to release static electricity and interference signals to the ground, thereby improving the anti-interference ability and anti-static field impact ability of the control unit 2711. In some embodiments, the control unit 2711 may be a control chip, for example, a QCC3024 control chip. Specifically, the QCC3024 control chip may be an entry-level flash programmable chip, with dual-mode Bluetooth zhiv5.0 audio SoC, VFBGA packaging and embedded three core processing architecture. The architecture may be composed of a pair of programmable 32-bit application processors and a configurable DSP audio subsystem. In some embodiments, the audio power amplifier 2712 may be an audio power amplifier of class D with an electrostatic protection function. When there is too much static electricity in the audio power amplifier circuit 110-6, the audio power amplifier of class D may trigger the static electricity protection function, turn off the audio power amplifier of class D, and release the static electricity to the ground through the grounding terminal.

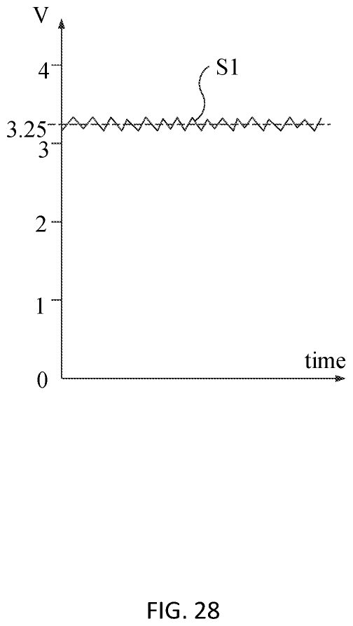

FIG. 28 is a first waveform diagram of a feedback signal according to some embodiments of the present disclosure. In some embodiments, when the audio power amplifier 2712 operates normally, the feedback unit 2713 may generate a feedback signal of the first form (shown as the first waveform “S1” in FIG. 28) according to the output of the audio power amplifier 2712. As shown in FIG. 28, the first waveform S1 has a first fluctuation located above and below the first predetermined voltage. In this embodiment, the first predetermined voltage may be 3.25 V, the first fluctuation may be irregular fluctuation on both sides above and below 3.25 V, and the fluctuation amplitude of the first fluctuation is less than 0.5 V.

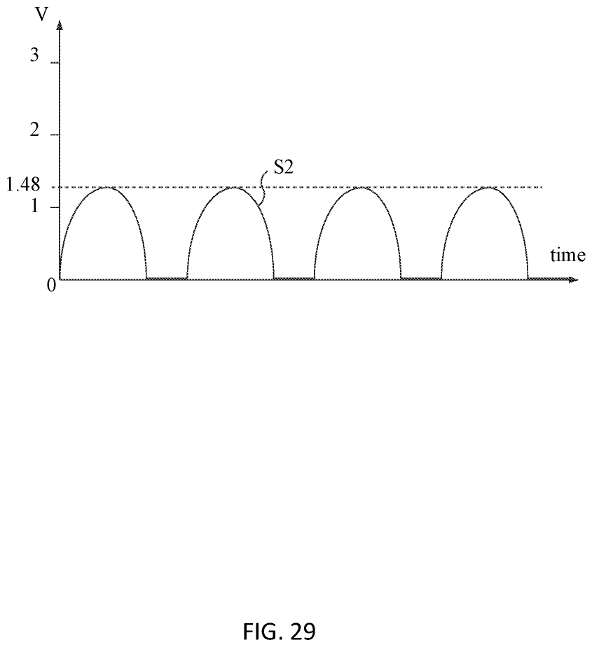

FIG. 29 is a schematic diagram of a second waveform of a feedback signal according to some embodiments of the present disclosure. In some embodiments, when the audio power amplifier 2712 triggers the electrostatic protection function, the audio power amplifier 2712 is in a closed state, and the audio power amplifier 2712 is in an abnormal working state. In some embodiments, the feedback unit 2713 may generate a feedback signal of a second form (shown as a second waveform “S2” in FIG. 29) according to the output of the audio power amplifier 2712. As shown in FIG. 29, the second waveform S2 has a second fluctuation on the side of the second predetermined voltage. In this embodiment, the second predetermined voltage may be 0 V, and the second fluctuation may be a positive half wave between 0 V and 2 V. For example, the fluctuation amplitude of the second fluctuation may be greater than 1 V, and the peak value of the second fluctuation may be 1.48 V. In some embodiments, the second fluctuation may consist of a plurality of identical cycles, and one cycle may be formed by a half sine wave and a zero level. Comparing FIG. 28 with FIG. 29, it may be seen that the first predetermined voltage in FIG. 28 is 3.25 V, and the second predetermined voltage in FIG. 29 is 0 V, that is, the first predetermined voltage is greater than the second predetermined voltage. The amplitude of the first wave in FIG. 28 is less than 0.5 V, and the amplitude of the second wave in FIG. 29 is greater than 1 V, that is, the amplitude of the first wave is less than the amplitude of the second wave.

In some embodiments, the input terminal of the control unit 2711 may determine the operating state of the audio power amplifier 2712 according to different forms of the received feedback signal. For example, when the control unit 2711 receives the feedback signal in the first form, the control unit 2711 may determine that the audio power amplifier 2712 is working normally. For another example, when the control unit 2711 receives the feedback signal in the second form, the control unit 2711 may judge that the audio power amplifier 2712 is abnormal, and send an enable control signal to the audio power amplifier 2712 through the enable output terminal to restart the audio power amplifier 2712. In some embodiments, the input of the control unit 2711 may be the I/O port of the control chip, and the shape of the feedback signal received by the input of the control unit 2711 may be determined according to the level change of the I/O port of the control chip.

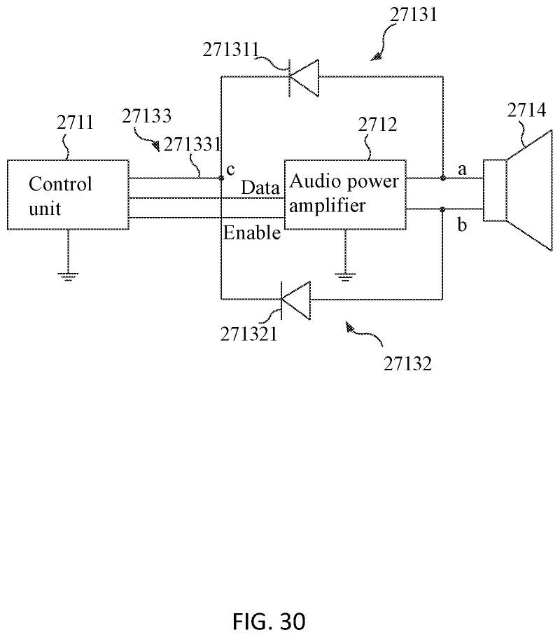

FIG. 30 is an exemplary structural diagram of an audio power amplifier circuit according to some embodiments of the present disclosure. As shown in FIG. 30, the audio power amplifier circuit 110-6 may further include a speaker 2714. In some embodiments, the audio power amplifier 2712 may include a first output terminal and a second output terminal, wherein the first output terminal and the second output terminal may be respectively connected to the speaker 2714 to drive the speaker 2714 to output sound signals. Specifically, the first output end of the audio power amplifier 2712 may be configured to output the first channel output signal to the speaker 2714, the second output end of the audio power amplifier 2712 may be configured to output the second channel output signal to the speaker 2714, the first channel output signal and the second channel output signal may form a differential signal, and the audio power amplifier circuit 110-6 may drive the speaker 2714 through the differential signal formed by the first channel output signal and the second channel output signal.

In some embodiments, the feedback unit 2713 may include a first feedback branch 27131, a second feedback branch 27132, and an integration branch 27133. In some embodiments, a first node a may be formed between the first output end of the audio power amplifier 2712 and the speaker 2714, and one end of the first feedback branch 27131 is connected to the first node a for receiving and processing the first output signal. A second node b may be formed between the second output end of the audio power amplifier 2712 and the speaker 2714, and one end of the second feedback branch 27132 is connected to the second node b for receiving and processing the second output signal. A third node c may be formed between the other end of the first feedback branch 27131 and the other end of the second feedback branch 27132. One end of the integration branch 27133 is connected to the third node c for integrating the processed two output signals to generate corresponding feedback signals. Here, the integration of the processed two output signals to generate the corresponding feedback signal may be understood as the superposition of the respective feedback signals of the processed two output signals to generate the final feedback signal. The reason why the two feedback signals are superimposed here is that the feedback signal output by a single channel in the first feedback branch 27131 and the second feedback branch 27132 may be very small (e.g., the strength of the feedback signal is very small or there is no feedback signal), and superimposing the two output signals may produce a relatively stable feedback signal. The other end of the integration branch 27133 is connected to the input of the control unit 2711 to output a feedback signal to the control unit 2711. In some embodiments, the first feedback branch 27131 may include a rectifying device 271311, which may be connected between the first node a between the first output end of the audio power amplifier 2712 and the speaker 2714, and the integration branch 27133 to receive the first output signal and perform rectification and filtering processing on the first output signal. The second feedback branch 27132 may include a second rectifying device 271321, which may be connected between the second node b between the second output end of the audio power amplifier 2712 and the speaker 2714, and the integration branch 27133 to receive the second output signal and perform a second rectifying and filtering on the second output signal.

In some embodiments, the first rectifying device 271311 and the second rectifying device 271321 may be of the same type. For example, the first rectifying device 271311 and the second rectifying device 271321 may both be rectifying diodes, rectifying transistors, thyristor rectifiers, etc. In some embodiments, the types of the first rectifying device 271311 and the second rectifying device 271321 may also be different. For example, the first rectifying device 271311 is a rectifier diode, and the second rectifying device 271321 is a thyristor rectifier. For another example, the first rectifying device 271311 is a rectifying transistor, and the second rectifying device 271321 is a rectifying diode. In some embodiments, the integration branch 27133 may include a wire 271331, one end of the wire 271331 may be connected to the third node c between the first feedback branch 27131 and the second feedback branch 27132, and the other end of the wire 271331 may be connected to the input of the control unit 2711 to integrate the processed two output signals to generate a feedback signal, and transmit the feedback information to the control unit 2711.

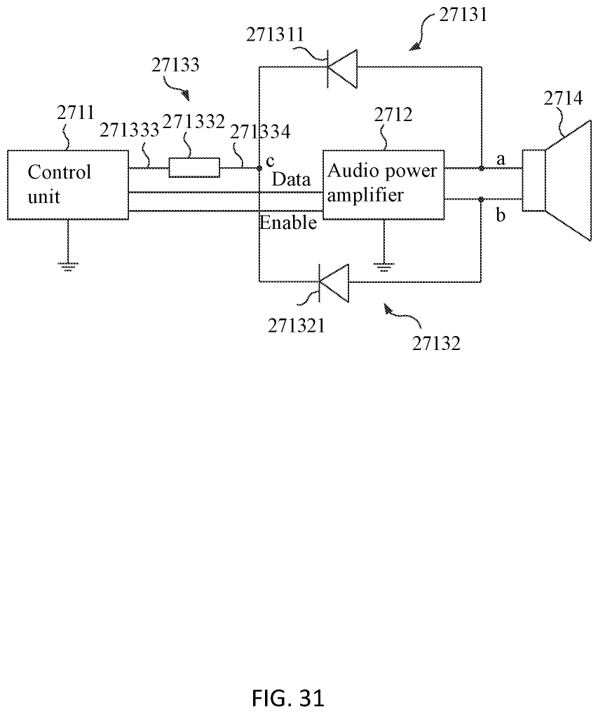

FIG. 31 is an exemplary structural diagram of an audio power amplifier circuit according to other embodiments of the present disclosure. FIG. 31 is substantially the same as FIG. 30, except that the integration branch 27133 of FIG. 31 may include a resistor 271332, a first wire 271333, and a second wire 271334. As shown in FIG. 31, one end of the resistance 271332 may be connected to the third node c between the first feedback branch 27131 and the second feedback branch 27132 through the first wire 271333, and the other end of the resistance 271332 may be connected to the control unit 2711 through the second wire 271334. The integration branch 27133 may integrate the processed two output signals to generate a feedback signal and transmit the feedback information to the control unit 2711.

In some embodiments, when the electrostatic current in the audio power amplifier circuit 110-6 is too large, the resistance 271332 may reduce the electrostatic current, thereby preventing damage to the control unit 2711 caused by the excessive electrostatic current. In some embodiments, the audio power amplifier circuit 110-6 is disposed with a feedback unit 2713 between the control unit 2711 and the audio power amplifier 2712. Through the feedback unit 2713, the output of the audio power amplifier 2712 may be converted into a feedback signal and output to the control unit 2711, so that the control unit 2711 may judge the working state of the audio power amplifier 2712 according to different forms of the feedback signal, and then output the enabling control signal according to the working state of the audio power amplifier 2712, control the restart of audio power amplifier 2712 to realize the self starting function of audio power amplifier 2712. In some embodiments, the integration branch 27133 is disposed with a resistance 271332 connected to the control unit 2711, the first feedback branch 27131 and the second feedback branch 27132, which can prevent damage to the control unit 2711 caused by excessive electrostatic current. In some embodiments, the audio power amplifier circuit 110-6 may be disposed in a signal processing circuit inside the rechargeable electronic device 130. For example, the audio power amplifier circuit 110-6 may be disposed in the signal processing circuit of the headphone device 130-1, thereby realizing the automatic restart of the headphone device 130-1 when the audio power amplifier has no output due to the electrostatic protection function.

The basic concepts have been described. Obviously, for those skilled in the art, the detailed disclosure may be only an example and does not constitute a limitation to the present disclosure. Although not explicitly stated here, those skilled in the art may make various modifications, improvements and amendments to the present disclosure. These alterations, improvements, and modifications are intended to be suggested by this disclosure, and are in the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. In addition, some features, structures, or features in the present disclosure of one or more embodiments may be appropriately combined.

In addition, those skilled in the art can understand that various aspects of the present disclosure may be illustrated and described through several patentable categories or situations, including any new and useful processes, machines, products, or combinations of materials, or any new and useful improvements. Accordingly, all aspects of the present disclosure may be performed entirely by hardware, may be performed entirely by softwares (including firmware, resident softwares, microcode, etc.), or may be performed by a combination of hardware and softwares. The above hardware or softwares may be referred to as “data block”, “module”, “engine”, “unit”, “component” or “system”. In addition, aspects of the present disclosure may appear as a computer product located in one or more computer-readable media, the product including computer-readable program code.

The computer storage medium may contain a propagated data signal containing a computer program code, for example, on baseband or as part of a carrier wave. The propagated signal may have multiple manifestations, including electromagnetic form, optical form, etc., or a suitable combination form. The computer storage medium may be any computer-readable medium other than the computer-readable storage medium, and the medium may be connected to an instruction execution system, device, or device to communicate, propagate, or transmit a program for use. The program code located on a computer storage medium may be transmitted through any suitable medium, including radio, cable, fiber optic cable, RF, or similar media, or any combination of the media.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may be completely run on the user's computer, run on the user's computer as a separate software package, partially run on the user's computer and partially run on the remote computer, or completely run on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider) or in a cloud computing environment or offered as a service such as a Software as a Service (SaaS).

Moreover, unless otherwise stated in the claims, the order of the processing elements and sequences of the present disclosure, the use of digital letters, or other names are not intended to limit the order of the disclosure processes and methods. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are in the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, FIG., or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, numbers describing the number of components and attributes are used. It should be understood that such numbers used in the description of embodiments are modified by the modifier “about”, “approximately” or “substantially” in some examples. Unless otherwise stated, “about”, “approximately”, or “substantially” indicates that the number is allowed to vary by ±20%. Accordingly, in some embodiments, the numerical parameters used in the specification and claims are approximate values, and the approximate values may be changed according to characteristics required by individual embodiments. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each patent, patent application, patent application publication and other materials cited herein, such as articles, books, instructions, publications, documents, etc., are hereby incorporated by reference in their entirety. Application history documents that are inconsistent or conflicting with the contents of the present disclosure are excluded, and documents (currently or later attached to the present disclosure) that limit the widest range of the scope of the present disclosure are also excluded. It should be noted that if there is any inconsistency or conflict between the description, definition, and/or terminology in the accompanying materials of the present disclosure and the content described in the present disclosure, the description, definition, and/or terminology in the present disclosure shall prevail.

At last, it should be understood that the embodiments described in the present disclosure are merely illustrative of the principles of the embodiments of the present disclosure. Other modifications that may be employed may be in the scope of the present disclosure. Thus, by way of example, but not of limitation, alternative structures of the embodiments of the present disclosure may be utilized in accordance with the teachings herein. Accordingly, embodiments of the present disclosure are not limited to that precisely as shown and described.

1. A charging control circuit, comprising:
a charging circuit, configured to be connected to a charging line or an external device, wherein the charging circuit generates a charging voltage difference after being connected to the charging line or the external device;
a detection circuit, including at least one detection terminal, wherein the detection circuit is configured to detect voltage information of the at least one detection terminal; and
a control circuit, configured to perform a predetermined action based on the charging voltage difference and the voltage information.

2. The charging control circuit of claim 1, wherein the voltage information at least includes a voltage value and/or a voltage change value of the at least one detection terminal, and wherein to perform the predetermined action based on the charging voltage difference and the voltage information, the control circuit performs operations including:
in response to the charging voltage difference and the voltage value and/or the voltage change value of the at least one detection terminal satisfying a predetermined condition, performing the predetermined action.

3. The charging control circuit of claim 2, wherein the predetermined condition includes: the charging circuit generates the charging voltage difference, and the voltage value and/or the voltage change value is greater than a predetermined value.

4. The charging control circuit of claim 1, wherein the charging circuit at least includes a first charging terminal and a second charging terminal, the first charging terminal and the second charging terminal are configured to contact electrode terminals corresponding to the charging line or the external device, and at least part of the at least one detection terminal is located between the first charging terminal and the second charging terminal.

5. The charging control circuit of claim 4, further comprising a shell configured to accommodate the charging circuit, the detection circuit, and the control circuit; wherein
an external surface of the shell is disposed with a charging slot,
the charging slot is disposed with a first electrode seat and a second electrode seat that are protruded from a bottom surface of the charging slot and disposed at intervals,
the first charging terminal and the second charging terminal are respectively embedded in the first electrode seat and the second electrode seat, and
at least part of the at least one detection terminal is located on the bottom surface of the charging slot between the first electrode seat and the second electrode seat, and lower than the first charging terminal and the second charging terminal.

6. The charging control circuit of claim 5, wherein the at least one detection terminal is exposed to the external surface of the shell; at least part of the at least one detection terminal is located on a connecting line between the first charging terminal and the second charging terminal, and extends on the external surface of the shell along a direction perpendicular to the connecting line.

7. The charging control circuit of claim 5, wherein the at least one detection terminal is a completely closed or not completely closed electrode structure, and the first charging terminal or the second charging terminal is located in a space region surrounded by the at least one detection terminal.

8. The charging control circuit of claim 4, further comprising:
a first voltage regulator, a first voltage dividing resistor, and a second voltage dividing resistor, one end of the first voltage dividing resistor is connected to the first voltage regulator, the other end of the first voltage dividing resistor is connected to the at least one detection terminal and one end of the second voltage dividing resistor, respectively, and the other end of the second voltage dividing resistor is grounded.

9. The charging control circuit of claim 8, further comprising:
the first charging terminal is a positive electrode terminal, the second charging terminal is a negative electrode terminal, the first voltage regulator is connected to the first charging terminal, the first voltage regulator is configured to output a processed voltage to the first voltage dividing resistor, wherein the processed voltage is obtained by stabilizing and reducing a voltage from the first charging terminal, and the other end of the second voltage dividing resistor is connected to the second charging terminal.

10. The charging control circuit of claim 1, further comprising:
an output module coupled with the control circuit, wherein the control circuit controls the output module to perform the predetermined action based on the charging voltage difference and the voltage information.

11. The charging control circuit of claim 1, wherein the charging line includes:
a power interface, configured to connect to a power adapter to receive a charging voltage;
a charging interface, configured to connect to the charging circuit;
a signal transmission line connected between the power interface and the charging interface, wherein the signal transmission line includes a charging-voltage transmission line and a ground-voltage transmission line; and
a current limiting device connected to the charging-voltage transmission line to limit a current through the charging interface.

12. The charging control circuit of claim 11, wherein the current limiting device is a self-adjusting resistor, and the greater the current through the self-adjusting resistor is, the greater a resistance value of the self-adjusting resistor is.

13. The charging control circuit of claim 11, wherein the current limiting device is disposed in the power interface, the charging interface, or the signal transmission line.

14. The charging control circuit of claim 11, wherein the charging line further includes a second voltage regulator connected between the charging-voltage transmission line and the ground-voltage transmission line to limit the charging voltage on the charging interface.

15. (canceled)

16. The charging control circuit of claim 11, wherein the power interface includes a first power terminal and a first ground terminal, the charging interface includes a second power terminal and a second ground terminal, the first power terminal of the power interface and the second power terminal of the charging interface are connected through the charging-voltage transmission line, and the first ground terminal of the power interface and the second ground terminal of the charging interface are connected through the ground-voltage transmission line.

17-18. (canceled)

19. The charging control circuit of claim 1, further comprising a voltage conversion circuit, wherein the voltage conversion circuit includes:
a switching power supply, the switching power supply comprising an input end and an output end, wherein the input end of the switching power supply is configured to receive an input voltage;
an inductive element, wherein one end of the inductive element is connected to the output end of the switching power supply, and the other end of the inductive element is configured as an output end of the voltage conversion circuit to generate an output voltage; and
a capacitive element, wherein one end of the capacitive element is connected to a first node between the output end of the switching power supply and the inductive element, and the other end of the capacitive element is connected to a ground voltage to adjust a change rate of a voltage of the first node.

20. The charging control circuit of claim 19, wherein the switching power supply includes:
a first working branch connected between the input end and the output end of the switching power supply for transmitting the input voltage to the first node;
a second working branch connected between the first node and the ground voltage for transmitting the ground voltage to the first node; and
a control chip, configured to control a switch-on or switch-off operation of the first working branch and the second working branch.

21-25. (canceled)

26. The charging control circuit of claim 19, wherein the voltage conversion circuit further includes a first filter circuit, the first filter circuit includes a first capacitor, and the first capacitor is connected between the input end of the switching power supply and the ground voltage.

27. The charging control circuit of claim 19, wherein the voltage conversion circuit further includes a second filter circuit, the second filter circuit includes a second capacitor, and the second capacitor is connected between the output end of the switching power supply and the ground voltage.

28. An acoustic output device, comprising a charging control circuit, wherein the charging control circuit includes:
a charging circuit, configured to be connected to a charging line or an external device, wherein the charging circuit generates a charging voltage difference after being connected to the charging line or the external device;
a detection circuit, including at least one detection terminal, wherein the detection circuit is configured to detect voltage information of the at least one detection terminal; and
a control circuit, configured to perform a predetermined action based on the charging voltage difference and the voltage information.

29-36. (canceled)
